(19) United States
(12) Patent Application Publication
(10) Pub. No.: US 2025/0269804 A1
(43) Pub. Date: Aug. 28, 2025

(54) VERTICAL HANGING BICYCLE CARRIER

(71) Applicant: Thule Sweden AB, HILLERSTORP (SE)

(72) Inventors: Samuel Atting Thorin, Jönköping (SE); Praveen Saladi, Jönköping (SE); Tam Le, Värnamo (SE); Jimmy Hjulfors, Jönköping (SE); Oliver Berg, Värnamo (SE); Vanesa AHMETSPAHIC, Värnamo (SE)

(21) Appl. No.: 19/060,121

(22) Filed: Feb. 21, 2025

Related U.S. Application Data
(60) Provisional application No. 63/634,143, filed on Apr. 15, 2024.

(30) Foreign Application Priority Data
Feb. 23, 2024 (DE) 20 2024 100 872.3

(51) Int. Cl. B60R 9/10; B25H 1/00; B60R 9/06; B62H 3/04

(52) U.S. Cl. CPC B60R 9/10; B25H 1/0014; B60R 9/06; B62H 3/04

(57) ABSTRACT

A vehicle mounted load carrier can include a hub, a support member, a tilt release mechanism, and atilt memory actuator. The support member rotatably can couple to the hub. The tilt release mechanism can couple to the support member. The tilt release mechanism can include a locking arm configured to move between a locked configuration and a released configuration. In the locked configuration the support member can be fixed relative to the hub. In the released configuration the support member can rotate between a first position and a second position. The tilt memory actuator can moveably couple to the hub or the support member. The tilt memory actuator can be configured to maintain the locking arm in the released configuration when the locking arm is actuated from the locked configuration to the released configuration.

### CROSS REFERENCE TO RELATED APPLICATIONS

This application claims priority to U.S. Provisional Application No. 63/634,143, filed Apr. 15, 2024, and German Utility Model Patent Application No. 20 2024 100 872.3, filed Feb. 23, 2024, which is hereby incorporated herein in its entirety by reference.

### BACKGROUND

### Field

The present disclosure relates to load carriers. More specifically, embodiments of the present disclosure relate to vehicle mounted load carriers, for example, bicycle carriers.

### Background

Devices for carrying equipment on a vehicle can be used to transport the equipment from one place to another. In some examples, the load carrier can be secured to the vehicle safely and conveniently via a hitch, typically attached to the rear of the vehicle. Various mechanisms can be used to secure a load (e.g., a bicycle) to the load carrier, for example, straps and securement arms. However, in certain cases these devices can be cumbersome, unstable, difficult to use, limit the capacity of the load carrier, limit the size of bicycle wheel that can be secured to the load carrier, or fail to securely fasten or balance the bicycle to the load carrier in a sufficient manner. Further, load carriers attached to the rear of a vehicle can block access to trunks or rear vehicle doors.

Other load carrier systems can include carrying arrangements for carrying, for example, a license plate or a lighting assembly. These load carrier systems may include foldable load support platforms on which the carrying arrangements are fastened. If the load support platform is transferred from a use position into a stowage position, this can lead to an object fastened on the carrying arrangement no longer being visible or protruding from the load support platform in an unfavorable manner.

### BRIEF SUMMARY

Accordingly, there is a need to provide a load carrier to accommodate bicycle wheels of all sizes, assist in tilting between configurations, and improve user operation and safety of the tilt operation between in-use and loading configurations.

In some embodiments, a vehicle mounted load carrier includes a hub, a support member, a tilt release mechanism, and a tilt memory actuator. In some embodiments, the support member can be rotatably coupled to the hub. In some embodiments, the tilt release mechanism can couple to the support member. In some embodiments, the tilt release mechanism can include a locking arm configured to move between a locked configuration and a released configuration. In some embodiments, in the locked configuration the support member is fixed relative to the hub. In some embodiments, in the released configuration the support member can rotate between a first position and a second position. In some embodiments, the tilt memory actuator can moveably couple to the hub or the support member and configured to maintain the locking arm in the released configuration when the locking arm is actuated from the locked configuration to the released configuration.

In some embodiments, a plurality of recesses can be formed in the hub or the support member. In some embodiments, the tilt memory actuator can move between a closed configuration and an open configuration. In some embodiments, in the closed configuration the tilt memory actuator is disposed over at least a portion of a first recess of the plurality of recesses. In some embodiments, the tilt memory actuator can linearly translate between the closed configuration and the open configuration. In some embodiments, in the closed configuration, the tilt memory actuator entirely covers the first recess.

In some embodiments, the tilt memory actuator can be biased into the closed configuration. In some embodiments, the locking arm can be disposed in the first recess in the locked configuration. In some embodiments, the plurality of recesses can be formed in the hub.

In some embodiments, the tilt memory actuator can include an actuating surface and a platform surface. In some embodiments, the platform surface can be configured to maintain the locking arm in the released configuration. In some embodiments, the locking arm can be configured to contact the actuating surface of the tilt memory actuator when the support arm is rotated in a first direction to move the tilt memory actuator into the open configuration. In some embodiments, the platform surface can be configured to maintain the locking arm in the released configuration when the support arm is rotated in a second direction opposite the first direction. In some embodiments, the platform surface is spaced apart from and disposed above a hub surface of the hub.

In some embodiments, the tilt memory actuator can moveably couple to the hub. In some embodiments, the support member can be configured to rotate to a third position different from the first position and the second position. In some embodiments, the tilt memory actuator can include a plate and a protrusion. In some embodiments, the protrusion can be configured to maintain the locking arm in the released configuration. In some embodiments, a plurality of recesses can be formed in the hub. In some embodiments, the tilt memory actuator can move between a closed configuration and an open configuration. In some embodiments, in the closed configuration the protrusion is disposed above at least one recess of the plurality of recesses.

In some embodiments, a load carrier includes a hub, a support member, and a first cover. In some embodiments, the hub can include a channel formed in the hub. In some embodiments, the channel can have a first end and a second end. In some embodiments, the support member can moveably couple to the hub and be disposed in the channel. In some embodiments, the first cover can couple to the hub or the support member. In some embodiments, the first cover can be configured to cover a portion of the channel between the first end and the support member when the support member is rotated between a first support position and a second support position.

In some embodiments, a second cover can be configured to cover a portion of the channel between the second end and the support member. In some embodiments, the first cover can couple to the hub and biased towards the support member. In some embodiments, the first cover can contact the support member and can slide along the support member.

In some embodiments, the first cover can slide along the hub or the support member. In some embodiments, the first cover can slide along the support member. In some embodiments, the first cover can couple to the hub. In some embodiments, the first cover can include a first sidewall disposed on a first side of the support member and a second sidewall disposed on a second side of the support member opposite the first side.

In some embodiments, the first cover can rotatably couple to the hub. In some embodiments, movement of the support member from a first position to a second position can move the first cover. In some embodiments, the load carrier can be a bicycle carrier.

In some embodiments, a bicycle carrier includes a wheel hoop arm and a wheel insert. In some embodiments, the wheel hoop arm can include a first end and a second end. In some embodiments, the wheel hoop arm can be configured to receive and support a bicycle wheel. In some embodiments, the wheel insert can removably couple the first end of the wheel hoop arm and be configured to reduce a wheel receiving length of the wheel hoop arm.

In some embodiments, the wheel insert can include a plurality of flanges configured to receive a perimeter rim of the wheel hoop arm. In some embodiments, a first flange of the plurality of flanges can couple with the perimeter rim of the wheel hoop arm. In some embodiments, an outer wall of the wheel insert cam include a profile configured to match a perimeter rim profile of the wheel hoop arm.

In some embodiments, the wheel insert can include a first support edge configured to support a first wheel having a first diameter. In some embodiments, the wheel insert can include a second support edge configured to support a second wheel having a second diameter different from the first diameter. In some embodiments, a first wheel receiving length can extend from the first support edge to the second end of the wheel hoop arm. In some embodiments, a second wheel receiving length can extend from the second support edge to the second end of the wheel hoop arm. In some embodiments, the second wheel receiving length can be less than the first wheel receiving length.

In some embodiments, a wall can extend between the first support edge and the second support edge. In some embodiments, the wall, the first support edge, and a portion of the wheel hoop arm can form a wheel receiving channel for the bicycle wheel. In some embodiments, a second wheel insert can couple to the second end of the wheel hoop arm and be configured to further reduce the wheel receiving length of the wheel hoop arm.

In some embodiments, a vehicle mounted load carrier includes a hub, a support member, and a tilt-assist device. In some embodiments, the support member can rotatably couple to the hub. In some embodiments, the support member can be configured to rotate between a first position and a second position. In some embodiments, the tilt-assist device can couple to the hub and the support member. In some embodiments, the tilt-assist device can be configured to control a rate of rotation of the support member between the first position and the second position, to assist the support member moving from the second position to the first position, or both.

In some embodiments, the tilt-assist device can be arranged on a first side of the support member. In some embodiments, an aperture can be formed through the support member, and the tilt-assist device extends through the aperture.

In some embodiments, the tilt-assist device can include a damping unit and a spring unit. In some embodiments, the damping unit can be arranged parallel to the spring unit. In some embodiments, the damping unit can be arranged on a first side of the support member, and the spring unit can be arranged on a second side of the support member opposite the first side.

In some embodiments, the tilt-assist device can include a gas spring. In some embodiments, the gas spring can include an actuator. In some embodiments, the gas spring can assist rotation of the support member from the second position to the first position when the actuator is actuated.

In some embodiments, the tilt-assist device can include a sensor to detect a load on the support member. In some embodiments, the tilt-assist device can adjust the rate of rotation or a force provided to assist the support member moving from the second position to the first position based on the load.

In some embodiments, the tilt-assist device can be configured to reduce vibration in the support member during transportation by the vehicle.

In some embodiments, a bicycle carrier includes a support member and a wheel hoop arm. In some embodiments, the wheel hoop arm can couple to the support member and be configured to receive a bicycle wheel. In some embodiments, the wheel hoop arm can include an angled support, a first coupling portion, a second coupling portion, and a recess portion. In some embodiments, the angled support can extend away from the support member. In some embodiments, the first coupling portion and the second coupling portion can extend from the angled support and be configured to receive and support the bicycle wheel. In some embodiments, the recess portion can be opposite the angled support and extend between the first and second coupling portions.

In some embodiments, the wheel hoop arm can be formed from a single bar. In some embodiments, the angled support can include a coupling bracket configured to couple to the support member. In some embodiments, the coupling bracket can include a plurality of angle position apertures to adjust an angle of the wheel hoop arm relative to the support member.

In some embodiments, the first coupling portion and the second coupling portion can be tapered. In some embodiments, the angled support member can extend at an acute angle relative to the support member. In some embodiments, the angled support and the recess can receive the wheel hub, the wheel spokes, or both.

In some embodiments, a bicycle carrier can include a support member and a wheel hoop arm. In some embodiments, the wheel hoop arm can couple to the support member and be configured to receive a bicycle wheel. In some embodiments, the wheel hoop arm can include a coupling member configured to couple with the support member in a plurality of angular orientations.

In some embodiments, the coupling member can include a plurality of angle position apertures. In some embodiments, the wheel hoop arm can have a first orientation when a fastener extends through a first aperture of the plurality of angle position apertures to couple the wheel hoop arm with the support member. In some embodiments, the wheel hoop arm can have a second orientation different from the first orientation when the fastener extends through a second aperture of the plurality of angle position apertures to couple the wheel hoop arm with the support member.

In some embodiments, a protruding bolt can be configured to secure a fastening member to a support member. In some embodiments, the protruding bolt includes a coupling shaft, a spacing shaft, and a bolt head. In some embodiments, the coupling shaft can be configured to couple to the support member. In some embodiments, the spacing shaft can extend away from the coupling shaft. In some embodiments, the bolt head can be spaced apart from the coupling shaft by the spacing shaft. In some embodiments, the fastening member can be disposed around the spacing shaft when the fastening member is secured to the protruding bolt.

In some embodiments, a strap for securing equipment to an equipment carrier can include a first end, a second end, and a plurality of apertures. In some embodiments, the first end can include a coupling aperture. In some embodiments, the second end can include a grip portion. In some embodiments, the plurality of apertures can be formed through the strap. In some embodiments, each aperture of the plurality of apertures can include a countersunk surface.

In some embodiments, an assembly for securing equipment to an equipment carrier can include the protruding bolt and the strap.

In some embodiments, an assembly for securing equipment to an equipment carrier can include a support member, a protruding bolt, and a strap. In some embodiments, the protruding bolt can couple to the support member. In some embodiments, the protruding bolt can include a coupling shaft, a spacing shaft, and a bolt head spaced apart from the support member by the spacing shaft. In some embodiments, the strap can include a plurality of apertures. In some embodiments, at least one of the plurality of apertures can removably couple with the protruding bolt.

In some embodiments, the strap further can include a first end and a second end. In some embodiments, the first end can couple to the support member. In some embodiments, a coupling aperture can be formed through the first end of the strap and be configured to receive a bolt that couples the strap to the support member. In some embodiments, the second end can include a grip portion.

In some embodiments, each aperture of the plurality of apertures can include a countersunk surface. In some embodiments, the spacing shaft can be disposed within an aperture of the plurality of aperture of the strap and the strap can be disposed between the bolt head and the support member when the strap is removably coupled to the protruding bolt. In some embodiments, the spacing shaft can include a square cross-sectional shape.

In some embodiments, a bicycle carrier includes an upper support, a lower support, and a wheel cradle. In some embodiments, the upper support can be configured to secure a first bicycle wheel to the bicycle carrier. In some embodiments, the lower support can be disposed below the upper support. In some embodiments, the wheel cradle can couple to the lower support and be configured to secure a second bicycle wheel to the bicycle carrier. In some embodiments, the wheel cradle can be formed from bent wire.

In some embodiments, the wheel cradle can have triangular shape. In some embodiments, the wheel cradle can taper from a wheel receiving end to a coupling portion with the lower support.

In some embodiments, a vehicle mounted load carrier includes a hub, a support member, and a tilt-release mechanism. In some embodiments, the hub can include a plurality of recesses formed in the hub. In some embodiments, the support member can rotatably couple to the hub. In some embodiments, the tilt-release mechanism can be configured to engage a first recess of the plurality of recesses formed in the hub to lock a relative position between the support arm and the hub. In some embodiments, the tilt release mechanism can include an actuator coupled to the support member.

In some embodiments, the actuator can be a strap, a button, a knob, a lever, or a handle. In some embodiments, the support member can include a first end rotatably coupled to the hub and a second end opposite the first end. In some embodiments, the actuator can be disposed along the support member and be spaced apart from the first end and the second end. In some embodiments, the locking arm can be biased towards the hub.

In some embodiments, the tilt-release mechanism can include a locking arm configured to move between a locked configuration and a released configuration. In some embodiments, the tilt-release mechanism can include a linkage coupled to the actuator and the locking arm. In some embodiments, in the locked configuration the locking arm can be received in one of the plurality of recesses of the hub and prevents rotation of the support arm relative to the hub. In some embodiments, when the actuator is operated, the locking arm can translate out of the recess to the released configuration such that the support arm can rotate relative to the hub. In some embodiments, the linkage can be disposed within the support member.

In some embodiments, a vehicle mounted load carrier includes a support member and an equipment lock. In some embodiments, the support member can have a proximal end disposed toward a vehicle and a distal end disposed opposite the proximal end. In some embodiments, the equipment lock can couple to the support member and be configured to secure a cable to the support member. In some embodiments, the equipment lock can be disposed at the distal end of the support member.

In some embodiments, the lock can include a lock barrel, a lock protrusion coupled to the lock barrel, and a spring configured to bias the lock protrusion into a locked position. In some embodiments, a locking notch can be formed in an end of the cable. In some embodiments, the lock protrusion can engage the locking notch to secure the cable to the base when the lock is disposed in a locked position.

In some embodiments, a vehicle mounted load carrier includes a hub, a support member, and a safety pin. In some embodiments, the support member can rotatably couple to the hub and be configured to rotate between a first position and a second position. In some embodiments, the safety pin can be configured to be disposed through an aperture formed in the hub. In some embodiments, the safety pin can be configured to prevent rotation of the support member from the first position to the second position. In some embodiments, a pin cradle can couple to the hub and be configured to receive the safety pin and secure the safety pin to the base.

In some embodiments, the safety pin can be L-shaped. In some embodiments, the safety pin can includes a shaft and a handle. In some embodiments, the handle can be received in the pin cradle to secure the handle to the hub. In some embodiments, the handle can be approximately perpendicular to the shaft.

In some embodiments, a safety wire can couple to the safety pin and the hub to secure the safety pin to the hub when the safety pin is not disposed through the aperture of the hub. In some embodiments, when the support member is in the second position, the support member can block the aperture in the hub. In some embodiments, the pin cradle can be configured to receive the safety pin when the safety pin is not disposed through the aperture of the hub.

In some embodiments, the bicycle carrier includes a support member and a bicycle work stand. In some embodiments, the support member can rotatably couple to a base. In some embodiments, the bicycle work stand can couple to the support member and be configured to support a bicycle.

In some embodiments, the support member can include a vertical arm and a horizontal arm. In some embodiments, the bicycle work stand can couple to the horizontal arm. In some embodiments, the bicycle work stand can rotatably couple to the support member and be moveable between a stowed position and an in-use position. In some embodiments, the bicycle work stand can extend away from the support member at an in-use angle such that a bicycle disposed on the work stand is disposed distally from the bicycle carrier.

In some embodiments, the bicycle work stand includes a support arm, a first support, and a second support. In some embodiments, the support arm can rotatably couple to the support member. In some embodiments, the first support can couple to a distal end of the support arm. In some embodiments, the second support can couple to the support arm below the first support. In some embodiments, the first support and the second support can be configured to contact the bicycle to support the bicycle.

In some embodiments, a groove can be formed in the first support to accommodate a seat component of the bicycle. In some embodiments, the second support can be configured to contact a seat post or a frame of the bicycle.

In some embodiments, a bicycle carrier includes a support member, a wheel hoop arm, and a wheel support. In some embodiments, the wheel hoop arm can couple to the support member and be configured to receive a bicycle wheel. In some embodiments, the wheel support can couple to the wheel hoop arm and contact the support member. In some embodiments, the wheel support can be configured to support the bicycle wheel.

In some embodiments, a vehicle mounted load carrier includes a base and a wheel assembly. In some embodiments, the base can be configured to transport a load. In some embodiments, the wheel assembly can couple to the base in at least one of a storage configuration and a transport configuration. In some embodiments, the wheel assembly can moveably couple to the base.

In some embodiments, the wheel assembly can include a wheel arm and a wheel. In some embodiments, the wheel arm can include a first end and a second end. In some embodiments, first end can rotatably couple to the base and the wheel can couple to the second end.

In some embodiments, a load carrier can include a carrying arrangement. In some embodiments, the carrying arrangement can be configured for carrying an object. In some embodiments, the object can be, for example, a license plate. In some embodiments, the object can be a lighting assembly. In some embodiments, the lighting assembly can include a tail light. In some embodiments, the carrying arrangement can be configured for carrying a plurality of objects, for example, for carrying a license plate and a lighting assembly. In some embodiments, the carrying arrangement can also be configured for carrying loads to be transported, for example a bicycle.

In some embodiments, the carrying arrangement includes a carrying portion for carrying the object and a supporting portion for supporting the carrying portion on the load carrier. In some embodiments, the supporting portion can be configured for supporting the carrying portion on a carrying frame of the load carrier or on a load support platform of the load carrier. In some embodiments, the carrying frame can be configured as described above in connection with other embodiments. In some embodiments, the load support platform can be configured as described above in connection with other embodiments.

In some embodiments, the carrying portion can be arranged in an articulated manner on the supporting portion. In some embodiments, the carrying portion can, in relation to the supporting portion, be arranged pivotable in a first direction about an axis of rotation between a use position and a stowage position.

In some embodiments, the carrying arrangement includes a locking arrangement. In some embodiments, the locking arrangement can be configured such that the carrying portion is locked in a form-fitting manner at least in the use position and a pivoting movement of the carrying portion to or into the stowage position is only possible when the carrying portion is moved before and/or during the pivoting movement in a second direction which differs from the first direction.

In some embodiments, the second direction can be a direction along or parallel to the axis of rotation.

In some embodiments, the locking arrangement can be configured such that pivoting of the carrying portion in the first direction from the use position into the stowage position and/or vice versa is only possible by previous movement of the carrying portion into a release position. In some embodiments, on reaching the release position, a movement of the carrying portion in the first direction can be released.

In some embodiments, the carrying portion can be movable in relation to the supporting portion along the axis of rotation and/or translationally, and a movement of the carrying portion into the release position can take place by moving along the axis of rotation and/or a translational movement of the carrying portion relative to the supporting portion.

In some embodiments, the locking arrangement includes a first engaging portion and a second engaging portion. In some embodiments, the first engaging portion can be associated with the carrying portion. In some embodiments, the second engaging portion can be associated with the supporting portion. In some embodiments, the first engaging portion and the second engaging portion can be configured such that they can come into form-fitting engagement when the carrying portion is in the use position.

In some embodiments, the first engaging portion and the second engaging portion can be configured complementary.

In some embodiments, the first engaging portion or the second engaging portion includes a recess and the respective other engaging portion can include a projection, which can engage in a form-fitting manner.

In some embodiments, the first engaging portion and the second engaging portion can be configured in the manner of claws of a claw coupling. In some embodiments, the first engaging portion includes a recess, which extends in the radial direction with respect to the axis of rotation and is indented in the axial direction, and the second engaging portion includes a projection, which extends radially with respect to the axis of rotation and protrudes in the axial direction and/or which extends in the radial direction with respect to the axis of rotation.

In some embodiments, the locking arrangement can be configured such that the carrying portion is automatically locked when the use position is reached. In some embodiments, the locking arrangement can be configured such that the first engaging portion engages with the second engaging portion when the use position is reached. In some embodiments, the first engaging portion can be pretensioned by means of an urging member in the direction of the second engaging portion. In some embodiments, the urging member includes a spring, for example a spiral spring.

In some embodiments, a license plate holding arrangement includes a carrying arrangement and a license plate holder. In some embodiments, the carrying arrangement can be a carrying arrangement as described above. In some embodiments, the carrying arrangement includes one or more features as described herein in connection with carrying arrangements. In some embodiments, the license plate holder can be fastened to the carrying arrangement.

In some embodiments, a load carrier includes a carrying frame, a load support platform and a carrying arrangement. In some embodiments, the supporting portion of the carrying arrangement can be attached to the load support platform. For example, the supporting portion can be attached to a rear portion of the load support platform.

Implementations of any of the techniques described above may include a system, a method, a process, a device, and/or an apparatus. The details of one or more implementations are set forth in the accompanying drawings and the description below. Other features will be apparent from the description and drawings, and from the claims.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate the embodiments and, together with the description, further serve to explain the principles and to enable a person skilled in the relevant art(s) to make and use the embodiments. Objects and advantages of illustrative, non-limiting embodiments will become more apparent by describing them in detail with reference to the attached drawings.

FIG. 1 illustrates a perspective view of a bicycle carrier coupled to a vehicle and supporting bicycles, according to an embodiment.

FIG. 2 illustrates a perspective view of a bicycle carrier in an in-use configuration, according to an embodiment.

FIG. 3 illustrates a side view of a bicycle carrier rotatable between an in-use configuration and a loading configuration, according to an embodiment.

FIGS. 4A-4C illustrate perspective views of a hub for a load carrier including a tilt memory actuator, with the hub in a plurality of positions, according to an embodiment.

FIGS. 5A-5D illustrate side views of a hub for a load carrier including the tilt memory actuator of FIGS. 4A-4C, with the tilt memory actuator in a plurality of positions, according to an embodiment.

FIG. 6A illustrates a perspective view of a tilt memory actuator, according to an embodiment.

FIG. 6B illustrates a cutaway perspective view of the tilt memory actuator of FIG. 6A, according to an embodiment.

FIGS. 7A-7B illustrate perspective views of the tilt memory actuator of FIG. 6A, according to an embodiment.

FIGS. 8A-8B illustrate perspective views of a tilt memory actuator, according to an embodiment.

FIGS. 9A-9C illustrate perspective views of a hub for a load carrier including covers, according to an embodiment.

FIG. 10A illustrates a side view of a hub for a load carrier with covers in an open configuration, according to an embodiment.

FIGS. 10B-10C illustrate perspective views a hub for a load carrier with covers in an open configuration, according to an embodiment.

FIG. 11 illustrates a perspective view of a wheel hoop arm including a wheel insert, according to an embodiment.

FIG. 12 illustrates a perspective view of the wheel insert of FIG. 11, according to an embodiment.

FIGS. 13A-13B illustrate perspective views of different sized bicycle wheels supported by a wheel insert and a wheel hoop arm, according to an embodiment.

FIGS. 14A-14E illustrate perspective views of wheel hoop arms, according to embodiments.

FIG. 15 illustrates a perspective view of a load carrier including a tilt-assist device, according to an embodiment.

FIGS. 16A-16B illustrate side views of a load carrier including a tilt-assist device in an in-use configuration and a loading configuration, according to an embodiment.

FIG. 17 illustrates a front view of a load carrier including a tilt-assist device, according to an embodiment.

FIGS. 18A-18B illustrate perspective views of a load carrier including a tilt-assist device in an in-use configuration and a loading configuration, according to an embodiment.

FIG. 19 illustrates a cutaway perspective view of a load carrier including a tilt-assist device, according to an embodiment.

FIGS. 20A-20C illustrate perspective views of a load carrier including a tilt-assist device, according to embodiments.

FIGS. 21A-21D illustrate wheel hoop arms, according to embodiments.

FIGS. 22A-22B illustrate front views of wheel hoop arms at a first orientation relative to a support member, according to an embodiment.

FIGS. 23A-23B illustrate front views of wheel hoop arms at a second orientation relative to a support member, according to an embodiment.

FIG. 24 illustrates an exploded view of a strap assembly, according to an embodiment.

FIG. 25 illustrates a perspective view of a strap assembly coupled to a support member, according to an embodiment.

FIG. 26 illustrates a perspective view of a wheel cradle with a strap assembly, according to an embodiment.

FIG. 27 illustrates a side view of a tilt-release actuator, according to an embodiment.

FIG. 28 illustrates an exploded perspective view of the tilt-release actuator of FIG. 27, according to an embodiment.

FIG. 29 illustrates a cutaway side view of a tilt-release mechanism, according to an embodiment.

FIG. 30 illustrates a perspective view of a locking arm of the tilt-release mechanism of FIG. 29, according to an embodiment.

FIG. 31 illustrates a perspective view of an equipment lock coupled to a support member with a cable secured to the equipment lock, according to an embodiment.

FIG. 32 illustrates a perspective view of an equipment lock, according to an embodiment.

FIG. 33 illustrates a perspective view of a hub with a safety pin for a load carrier in a release configuration, according to an embodiment.

FIGS. 34A-34B illustrate perspective views of the safety pin of FIG. 33 in a blocking configuration, according to an embodiment.

FIG. 35 illustrates a perspective view of a bicycle work stand in an in-use configuration, according to an embodiment.

FIG. 36 illustrates a perspective view of a bicycle work stand hub, according to an embodiment.

FIG. 37 illustrates a perspective view of a bicycle supported in a standing position by a bicycle carrier, according to an embodiment.

FIG. 38 illustrates a perspective view of a bicycle supported in a standing position by a bicycle carrier, according to an embodiment.

FIG. 39 illustrates a perspective view of a wheel support, according to an embodiment.

FIG. 40 illustrates a cutaway perspective view of a wheel assembly for a load carrier, according to an embodiment.

FIG. 41 illustrates a perspective view of a wheel assembly for a load carrier, according to an embodiment.

FIG. 42 illustrates a perspective view of a wheel assembly for a load carrier, according to an embodiment.

FIG. 43 illustrates a perspective view of a load carrier system, according to an embodiment.

FIG. 44 illustrates a perspective view of a carrying arrangement, according to an embodiment.

FIG. 45 illustrates a perspective view of the carrying arrangement of FIG. 44, showing the carrying arrangement arranged in a stowage position, according to an embodiment.

FIG. 46 illustrates a perspective view of an exemplary connection between a carrying portion and a supporting portion of the carrying arrangement of FIG. 44.

FIG. 47 illustrates the components of FIG. 46 in an exploded view.

FIG. 48 illustrates a perspective view of a license plate holding arrangement, according to an embodiment.

FIG. 49 illustrates a side view of components of the license plate holding arrangement of FIG. 48, showing a license plate holder is in a use position.

FIG. 50 illustrates a side view of components of the license plate holding arrangement of FIG. 48, showing the license plate holder is in a stowage position.

FIG. 51 illustrates an exploded view of components of a carrying arrangement, according to an embodiment.

FIG. 52 illustrates a perspective view of a supporting portion of the carrying arrangement of FIG. 51.

FIG. 53 illustrates a perspective view of the carrying arrangement of FIG. 51 partially in section.

FIGS. 54 to 56 illustrate an embodiment of a carrying arrangement.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value).

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

Embodiment 1 of the description—A vehicle mounted load carrier includes a hub; a support member rotatably coupled to the hub; a tilt release mechanism coupled to the support member, the tilt release mechanism including a locking arm configured to move between a locked configuration and a released configuration such that in the locked configuration the support member is fixed relative to the hub and in the released configuration the support member can rotate between a first position and a second position; and a tilt memory actuator moveably coupled to the hub or the support member and configured to maintain the locking arm in the released configuration when the locking arm is actuated from the locked configuration to the released configuration.

Embodiment 2 of the description—The load carrier of embodiment 1, wherein a plurality of recesses are formed in the hub or the support member, and wherein the tilt memory actuator moves between a closed configuration and an open configuration, wherein in the closed configuration the tilt memory actuator is disposed over at least a portion of a first recess of the plurality of recesses.

Embodiment 3 of the description—The load carrier of embodiment 2, wherein the tilt memory actuator linearly translates between the closed configuration and the open configuration.

Embodiment 4 of the description—The load carrier of embodiment 2, wherein in the closed configuration, the tilt memory actuator entirely covers the first recess.

Embodiment 5 of the description—The load carrier of embodiment 2, wherein the tilt memory actuator is biased into the closed configuration.

Embodiment 6 of the description—The load carrier of embodiment 2, wherein the locking arm is disposed in the first recess in the locked configuration.

Embodiment 7 of the description—The load carrier of embodiment 2, wherein the plurality of recesses are formed in the hub.

Embodiment 8 of the description—The load carrier of embodiment 2, wherein the tilt memory actuator includes an actuating surface and a platform surface, and wherein the platform surface is configured to maintain the locking arm in the released configuration.

Embodiment 9 of the description—The load carrier of embodiment 8, wherein the locking arm is configured to contact the actuating surface of the tilt memory actuator when the support arm is rotated in a first direction to move the tilt memory actuator into the open configuration.

Embodiment 10 of the description—The load carrier of embodiment 9, wherein the platform surface is configured to maintain the locking arm in the released configuration when the support arm is rotated in a second direction opposite the first direction.

Embodiment 11 of the description—The load carrier of embodiment 8, wherein the platform surface is spaced apart from and disposed above a hub surface of the hub.

Embodiment 12 of the description—The load carrier of embodiment 1, wherein the tilt memory actuator is moveably coupled to the hub.

Embodiment 13 of the description—The load carrier of embodiment 1, wherein the support member is further configured to rotate to a third position different from the first position and the second position.

Embodiment 14 of the description—The load carrier of embodiment 1, wherein the tilt memory actuator includes a plate and a protrusion, and wherein the protrusion is configured to maintain the locking arm in the released configuration.

Embodiment 15 of the description—The load carrier of embodiment 14, wherein a plurality of recesses are formed in the hub, and wherein the tilt memory actuator moves between a closed configuration and an open configuration, wherein in the closed configuration the protrusion is disposed above at least one recess of the plurality of recesses.

Embodiment 16 of the description—A load carrier includes a hub including a channel formed in the hub, the channel having a first end and a second end; a support member moveably coupled to the hub and disposed in the channel; and a first cover coupled to the hub or the support member, wherein the first cover is configured to cover a portion of the channel between the first end and the support member when the support member is rotated between a first support position and a second support position.

Embodiment 17 of the description—The load carrier of embodiment 16, further including a second cover configured to cover a portion of the channel between the second end and the support member.

Embodiment 18 of the description—The load carrier of embodiment 16, wherein the first cover is coupled to the hub and biased towards the support member.

Embodiment 19 of the description—The load carrier of embodiment 18, wherein the first cover contacts the support member and slides along the support member.

Embodiment 20 of the description—The load carrier of embodiment 16, wherein the first cover slides along the hub or the support member.

Embodiment 21 of the description—The load carrier of embodiment 20, wherein the first cover slides along the support member.

Embodiment 22 of the description—The load carrier of embodiment 16, wherein the first cover is coupled to the hub and the first cover includes a first sidewall disposed on a first side of the support member and a second sidewall disposed on a second side of the support member opposite the first side.

Embodiment 23 of the description—The load carrier of embodiment 16, wherein the first cover is rotatably coupled to the hub.

Embodiment 24 of the description—The load carrier of embodiment 16, wherein movement of the support member from a first position to a second position moves the first cover.

Embodiment 25 of the description—The load carrier of embodiment 16, wherein the load carrier is a bicycle carrier.

Embodiment 26 of the description—A bicycle carrier including a wheel hoop arm including a first end and a second end, wherein the wheel hoop arm is configured to receive and support a bicycle wheel; and a wheel insert removably coupled the first end of the wheel hoop arm and configured to reduce a wheel receiving length of the wheel hoop arm.

Embodiment 27 of the description—The bicycle carrier of embodiment 26, wherein the wheel insert includes a plurality of flanges configured to receive a perimeter rim of the wheel hoop arm.

Embodiment 28 of the description—The bicycle carrier of embodiment 27, wherein a first flange of the plurality of flanges couples with the perimeter rim of the wheel hoop arm.

Embodiment 29 of the description—The bicycle carrier of embodiment 26, wherein an outer wall of the wheel insert includes a profile configured to match a perimeter rim profile of the wheel hoop arm.

Embodiment 30 of the description—The bicycle carrier of embodiment 26, wherein the wheel insert includes a first support edge configured to support a first wheel having a first diameter, and a second support edge configured to support a second wheel having a second diameter different from the first diameter.

Embodiment 31 of the description—The bicycle carrier of embodiment 30, wherein a first wheel receiving length extends from the first support edge to the second end of the wheel hoop arm, and a second wheel receiving length extends from the second support edge to the second end of the wheel hoop arm.

Embodiment 32 of the description—The bicycle carrier of embodiment 31, wherein the second wheel receiving length is less than the first wheel receiving length.

Embodiment 33 of the description—The bicycle carrier of embodiment 30, wherein a wall extends between the first support edge and the second support edge, and wherein the wall, the first support edge, and a portion of the wheel hoop arm form a wheel receiving channel for the bicycle wheel.

Embodiment 34 of the description—The bicycle carrier of embodiment 26, further including a second wheel insert coupled to the second end of the wheel hoop arm and configured to further reduce the wheel receiving length of the wheel hoop arm.

Embodiment 35 of the description—A vehicle mounted load carrier including a hub; a support member rotatably coupled to the hub, wherein the support member is configured to rotate between a first position and a second position; and a tilt-assist device coupled to the hub and the support member, wherein the tilt-assist device is configured to: control a rate of rotation of the support member between the first position and the second position, to assist the support member moving from the second position to the first position, or both.

Embodiment 36 of the description—The load carrier of embodiment 35, wherein the tilt-assist device is arranged on a first side of the support member.

Embodiment 37 of the description—The load carrier of embodiment 35, wherein an aperture is formed through the support member, and the tilt-assist device extends through the aperture.

Embodiment 38 of the description—The load carrier of embodiment 35, wherein the tilt-assist device includes a damping unit and a spring unit.

Embodiment 39 of the description—The load carrier of embodiment 38, wherein the damping unit is arranged parallel to the spring unit.

Embodiment 40 of the description—The load carrier of embodiment 38, wherein the damping unit is arranged on a first side of the support member, and the spring unit is arranged on a second side of the support member opposite the first side.

Embodiment 41 of the description—The load carrier of embodiment 35, wherein the tilt-assist device includes a gas spring.

Embodiment 42 of the description—The load carrier of embodiment 41, wherein the gas spring includes an actuator, and wherein the gas spring assists rotation of the support member from the second position to the first position when the actuator is actuated.

Embodiment 43 of the description—The load carrier of embodiment 35, wherein the tilt-assist device includes a sensor to detect a load on the support member, and wherein the tilt-assist device adjusts the rate of rotation or a force provided to assist the support member moving from the second position to the first position based on the load.

Embodiment 44 of the description—The load carrier of embodiment 35, wherein the tilt-assist device is further configured to reduce vibration in the support member during transportation by the vehicle.

Embodiment 45 of the description—A bicycle carrier includes a support member; a wheel hoop arm coupled to the support member and configured to receive a bicycle wheel, the wheel hoop arm including: an angled support extending away from the support member, a first coupling portion and a second coupling portion extending from the angled support and configured to receive and support the bicycle wheel, and a recess portion opposite the angled support and extending between the first and second coupling portions.

Embodiment 46 of the description—The bicycle carrier of embodiment 45, wherein the wheel hoop arm is formed from a single bar.

Embodiment 47 of the description—The bicycle carrier of embodiment 45, wherein the angled support includes a coupling bracket configured to couple to the support member.

Embodiment 48 of the description—The bicycle carrier of embodiment 47, wherein the coupling bracket includes a plurality of angle position apertures to adjust an angle of the wheel hoop arm relative to the support member.

Embodiment 49 of the description—The bicycle carrier of embodiment 45, wherein the first coupling portion and the second coupling portion are tapered.

Embodiment 50 of the description—The bicycle carrier of embodiment 45, wherein the angled support member extends at an acute angle relative to the support member.

Embodiment 51 of the description—The bicycle carrier of embodiment 45, wherein the angled support and the recess receive the wheel hub, the wheel spokes, or both.

Embodiment 52 of the description—A bicycle carrier includes a support member; a wheel hoop arm coupled to the support member and configured to receive a bicycle wheel, wherein the wheel hoop arm includes a coupling member configured to couple with the support member in a plurality of angular orientations.

Embodiment 53 of the description—The bicycle carrier of embodiment 52, wherein the coupling member includes a plurality of angle position apertures.

Embodiment 54 of the description—The bicycle carrier of embodiment 53, wherein the wheel hoop arm has a first orientation when a fastener extends through a first aperture of the plurality of angle position apertures to couple the wheel hoop arm with the support member.

Embodiment 55 of the description—The bicycle carrier of embodiment 54, wherein the wheel hoop arm has a second orientation different from the first orientation when the fastener extends through a second aperture of the plurality of angle position apertures to couple the wheel hoop arm with the support member.

Embodiment 56 of the description—A protruding bolt configured to secure a fastening member to a support member, the protruding bolt including: a coupling shaft configured to couple to the support member; a spacing shaft extending away from the coupling shaft; and a bolt head spaced apart from the coupling shaft by the spacing shaft, wherein the fastening member is disposed around the spacing shaft when the fastening member is secured to the protruding bolt.

Embodiment 57 of the description—A strap for securing equipment to an equipment carrier, the strap including: a first end including a coupling aperture; a second end including a grip portion; and a plurality of apertures formed through the strap, wherein each aperture of the plurality of apertures includes a countersunk surface.

Embodiment 58 of the description—An assembly for securing equipment to an equipment carrier, the assembly including: the protruding bolt of embodiment 56; and the strap of embodiment 57.

Embodiment 59 of the description—An assembly for securing equipment to an equipment carrier, the assembly including: a support member; a protruding bolt coupled to the support member, wherein the protruding bolt including a coupling shaft, a spacing shaft, and a bolt head spaced apart from the support member by the spacing shaft; and a strap including a plurality of apertures, wherein at least one of the plurality of apertures removably couples with the protruding bolt.

Embodiment 60 of the description—The assembly of embodiment 59, wherein the strap further includes a first end and a second end, and wherein the first end is coupled to the support member.

Embodiment 61 of the description—The assembly of embodiment 60, wherein a coupling aperture is formed through the first end of the strap and configured to receive a bolt that couples the strap to the support member.

Embodiment 62 of the description—The assembly of embodiment 60, wherein the second end includes a grip portion.

Embodiment 63 of the description—The assembly of embodiment 59, wherein each aperture of the plurality of apertures includes a countersunk surface.

Embodiment 64 of the description—The assembly of embodiment 59, wherein the spacing shaft is disposed within an aperture of the plurality of aperture of the strap and the strap is disposed between the bolt head and the support member when the strap is removably coupled to the protruding bolt.

Embodiment 65 of the description—The assembly of embodiment 59, wherein the spacing shaft includes a square cross-sectional shape.

Embodiment 66 of the description—A bicycle carrier includes an upper support configured to secure a first bicycle wheel to the bicycle carrier; a lower support disposed below the upper support; and a wheel cradle coupled to the lower support and configured to secure a second bicycle wheel to the bicycle carrier, wherein the wheel cradle is formed from bent wire.

Embodiment 67 of the description—The bicycle carrier of embodiment 66, wherein the wheel cradle has triangular shape.

Embodiment 68 of the description—The bicycle carrier of embodiment 66, wherein the wheel cradle tapers from a wheel receiving end to a coupling portion with the lower support.

Embodiment 69 of the description—A vehicle mounted load carrier includes: a hub including a plurality of recesses formed in the hub; a support member rotatably coupled to the hub; and a tilt-release mechanism configured to engage a first recess of the plurality of recesses formed in the hub to lock a relative position between the support arm and the hub, wherein the tilt release mechanism includes an actuator coupled to the support member.

Embodiment 70 of the description—The load carrier of embodiment 69, wherein the actuator is a strap, a button, a knob, a lever, or a handle.

Embodiment 71 of the description—The load carrier of embodiment 69, wherein the support member includes a first end rotatably coupled to the hub and a second end opposite the first end, and wherein the actuator is disposed along the support member and spaced apart from the first end and the second end.

Embodiment 72 of the description—The load carrier of embodiment 69, wherein the tilt-release mechanism further includes a locking arm configured to move between a locked configuration and a released configuration, and a linkage coupled to the actuator and the locking arm,

Embodiment 73 of the description—The load carrier of embodiment 72, wherein in the locked configuration the locking arm is received in one of the plurality of recesses of the hub and prevents rotation of the support arm relative to the hub.

Embodiment 74 of the description—The load carrier of embodiment 73, wherein when the actuator is operated, the locking arm translates out of the recess to the released configuration such that the support arm can rotate relative to the hub.

Embodiment 75 of the description—The load carrier of embodiment 72, wherein the linkage is disposed within the support member.

Embodiment 76 of the description—The load carrier of embodiment 69, wherein the locking arm is biased towards the hub.

Embodiment 77 of the description—A vehicle mounted load carrier includes a support member having a proximal end disposed toward a vehicle and a distal end disposed opposite the proximal end; and an equipment lock coupled to the support member and configured to secure a cable to the support member, wherein the equipment lock is disposed at the distal end of the support member.

Embodiment 78 of the description—The load carrier of embodiment 77, wherein the lock includes a lock barrel, a lock protrusion coupled to the lock barrel, and a spring configured to bias the lock protrusion into a locked position, wherein a locking notch is formed in an end of the cable, and wherein the lock protrusion engages the locking notch to secure the cable to the base when the lock is disposed in a locked position.

Embodiment 79 of the description—A vehicle mounted load carrier includes: a hub; a support member rotatably coupled to the hub and configured to rotate between a first position and a second position; a safety pin configured to be disposed through an aperture formed in the hub, wherein the safety pin is configured to prevent rotation of the support member from the first position to the second position; and a pin cradle coupled to the hub and configured to receive the safety pin and secure the safety pin to the base.

Embodiment 80 of the description—The load carrier of embodiment 79, wherein the safety pin is L-shaped.

Embodiment 81 of the description—The load carrier of embodiment 79, wherein the safety pin includes a shaft and a handle, and wherein the handle is received in the pin cradle to secure the handle to the hub.

Embodiment 82 of the description—The load carrier of embodiment 81, wherein the handle is approximately perpendicular to the shaft.

Embodiment 83 of the description—The load carrier of embodiment 79, further including a safety wire coupled to the safety pin and the hub to secure the safety pin to the hub when the safety pin is not disposed through the aperture of the hub.

Embodiment 84 of the description—The load carrier of embodiment 79, wherein when the support member is in the second position, the support member blocks the aperture in the hub.

Embodiment 85 of the description—The load carrier of embodiment 79, wherein the pin cradle is configured to receive the safety pin when the safety pin is not disposed through the aperture of the hub.

Embodiment 86 of the description—A bicycle carrier includes a support member rotatably coupled to a base; and a bicycle work stand coupled to the support member and configured to support a bicycle.

Embodiment 87 of the description—The bicycle carrier of embodiment 86, wherein the support member includes a vertical arm and a horizontal arm, and wherein the bicycle work stand is coupled to the horizontal arm.

Embodiment 88 of the description—The bicycle carrier of embodiment 86, wherein the bicycle work stand is rotatably coupled to the support member and moveable between a stowed position and an in-use position.

Embodiment 89 of the description—The bicycle carrier of embodiment 86, wherein the bicycle work stand extends away from the support member at an in-use angle such that a bicycle disposed on the work stand is disposed distally from the bicycle carrier.

Embodiment 90 of the description—The bicycle carrier of embodiment 86, wherein the bicycle work stand includes a support arm rotatably coupled to the support member; a first support coupled to a distal end of the support arm; and a second support coupled to the support arm below the first support, wherein the first support and the second support are configured to contact the bicycle to support the bicycle.

Embodiment 91 of the description—The bicycle carrier of embodiment 90, wherein a groove is formed in the first support to accommodate a seat component of the bicycle.

Embodiment 92 of the description—The bicycle carrier of embodiment 91, wherein the second support is configured to contact a seat post or a frame of the bicycle.

Embodiment 93 of the description—A bicycle carrier includes a support member; a wheel hoop arm coupled to the support member and configured to receive a bicycle wheel; and a wheel support coupled to the wheel hoop arm and contacting the support member, wherein the wheel support is configured to support the bicycle wheel.

Embodiment 94 of the description—A vehicle mounted load carrier includes a base configured to transport a load; and a wheel assembly coupled to the base in at least one of a storage configuration; and a transport configuration, wherein the wheel assembly is moveably coupled to the base.

Embodiment 95 of the description—The load carrier of embodiment 94, wherein the wheel assembly includes a wheel arm and a wheel, wherein the wheel arm includes a first end and a second end, wherein the first end is rotatably coupled to the base and the wheel is coupled to the second end.

Embodiments of load carrier apparatuses, systems, and methods as discussed below can provide improved user operation for moving loads on a load carrier, improve safety by removing access to finger-trapping channels, increase versatility of the load carrier to accommodate different sized bicycle wheels, and assist and control tilting of a load carrier between different configurations.

### Example Tilt Memory Actuator

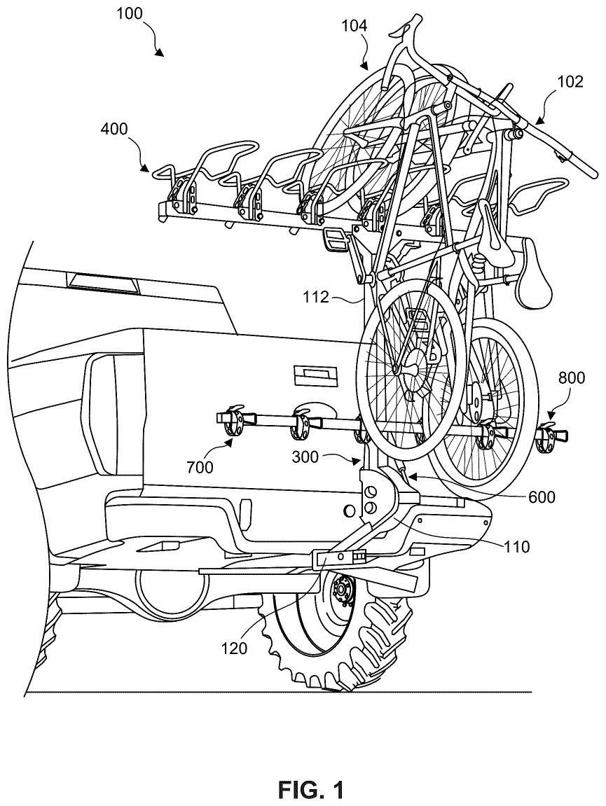

FIGS. 1-5D illustrate a load carrier system 100 with a tilt memory actuator 200, according to embodiments. Load carrier system 100 can be configured to secure and carry a load, for example, one or more bicycles 102, 104. Load carrier system 100 can be moved and/or tilted from a first position 10, such as when load carrier 100 is in an in-use position, to a second position 20, such as when load carrier 10 is being loaded or rotated away from a vehicle and in a loading position. Load carrier system 100 can include a tilt-release mechanism 900 that moves a locking arm 920 from a locked configuration 40 to a released configuration 50. When locking arm 920 is in the released configuration 50, load carrier system 100 can be moved from the first position 10 to the second position 20. Tilt memory actuator 200 can be configured to maintain locking arm 920 in the released configuration 50 when locking arm 920 is actuated from the locked configuration 40 to the released configuration 50. Although load carrier 100 with tilt memory actuator 200 is shown in FIGS. 1-5D as a stand-alone system, the embodiments of this disclosure can be used with other apparatuses and/or systems, such as, but not limited to the covers 300, wheel hoop arm 400, wheel insert 500, tilt-assist device 600, strap assembly 700, wheel cradle 800, tilt-release mechanism 900, equipment lock 1000, safety pin 1100, bicycle work stand 1200, wheel support 1300, and/or transport wheel assembly 1400.

In some embodiments, load carrier system 100 can include hub 110, support member 112, tilt-release mechanism 900, and/or tilt memory actuator 200 as shown, for example, in FIGS. 1-5D. In the illustrative embodiment shown in FIG. 1, load carrier system 100 can be a bicycle carrier to secure a plurality of bicycles 102, 104 in a vertical arrangement. In some embodiments, load carrier system 100 can be a bicycle carrier to secure bicycles in a horizontal arrangement. In some embodiments, load carrier system 100 can be any load carrying device that tilts or rotates between positions such as a cargo box, rooftop box, folding tent, foldable stroller, or other similar devices.

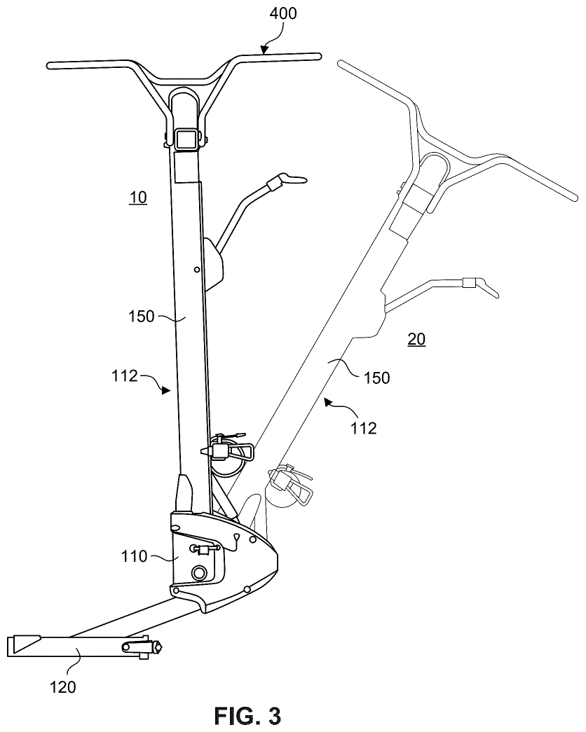

In the illustrative embodiment shown in FIGS. 1-3, support member 112 is coupled to hub 110 and configured to secure a plurality of bicycles 102, 104 to load carrier system 100. Support member 112 can move from first position 10 to a second position 20, or vice versa, as shown, for example, in FIG. 3. In some embodiments, first position 10 can be an in-use position. In some embodiments, second position 20 can be a tilt-down position, a loading position, and/or a vehicle clearance position. In some embodiments, support member 112 can move to a third position relative to hub 110, different from the first and second positions 10, 20.

In the illustrative embodiment shown in FIGS. 1-3, support member 112 can include a vertical support 150, a first horizontal support 152, and a second horizontal support 154. In some embodiments, first and second horizontal supports 152, 154 can be coupled to vertical support 150. In some embodiments, first and second horizontal supports 152, 154 extend perpendicularly to vertical support 150. In some embodiments, first horizontal support 152 can be an upper support and second horizontal support 154 can be a lower support such that first horizontal support 152 can be disposed above second horizontal support 154. In some embodiments, a plurality of wheel hoop arms 400 can couple to first horizontal support 152. In some embodiments, a plurality of wheel cradles 800 can couple to second horizontal support 154. In some embodiments, support member 112 can include a first side 156, a second side 158 opposite first side 156, a first end 160 moveably coupled with hub 110, and a second end 162 opposite first end 160.

As shown, for example, in FIGS. 1-4C, hub 110 can include vehicle attachment portion 120 that can couple load carrier system 100 to a vehicle. Hub 110 can include a hub body 122, a channel 124 formed in hub body 122, and a guide pin 128 coupled to and extending away from hub body 122. In some embodiments, guide pin 128 is received within a guide slot 216 of tilt memory actuator 200 to guide movement of tilt memory actuator 200. In some embodiments, hub body 122 supports movement and/or rotation of support member 112 between first and second positions 10, 20. Support member 112 can be moveably coupled to hub 110 via hub body 122 and can be moveably disposed in channel 124. In some embodiments, support member 112 rotates within and along channel 124 from first position 10 to second position 20 or vice versa. In some embodiments, channel 124 can include first end 140 and second end 142. In some embodiments, support member 112 is closer to first end 140 in first position 10 than second end 142. In some embodiments, support member 112 is closer to second end 142 in second position 20 than first end 140.

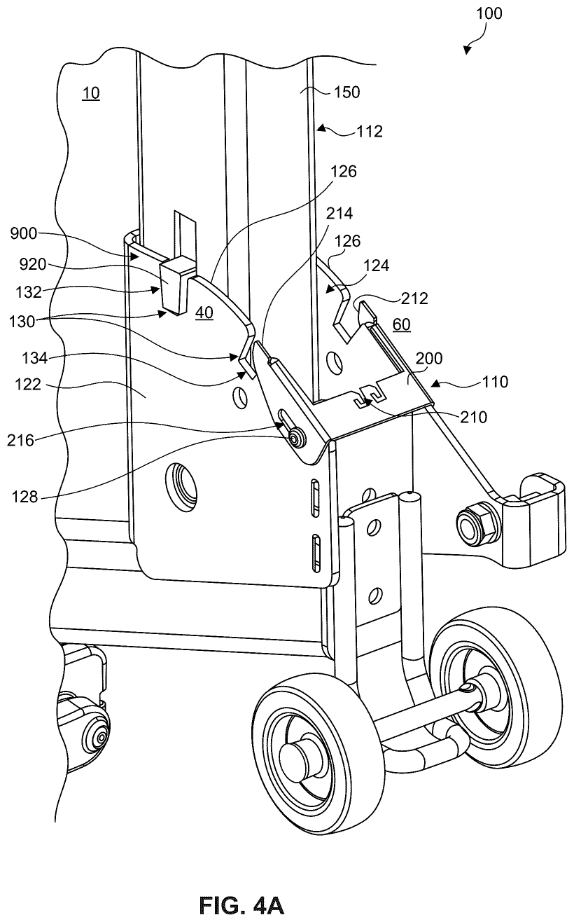

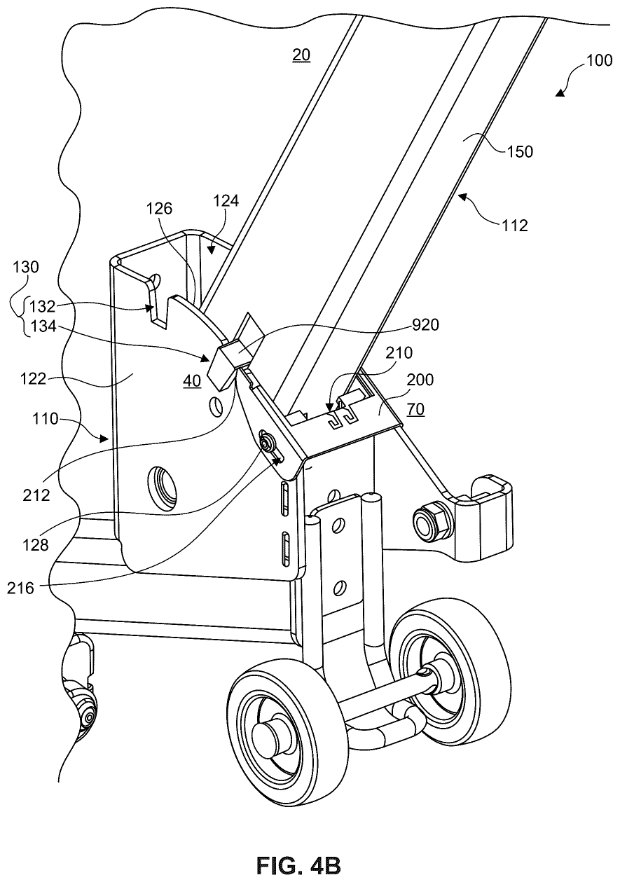

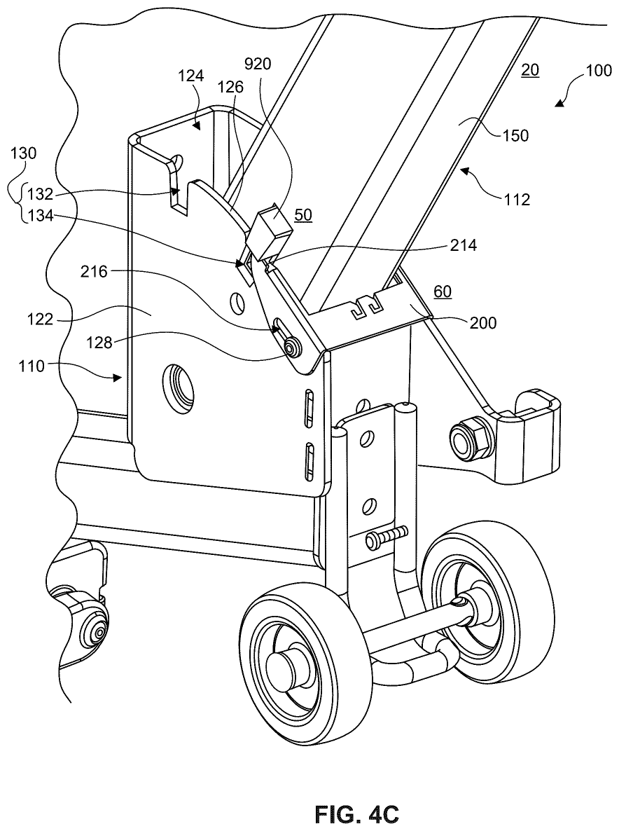

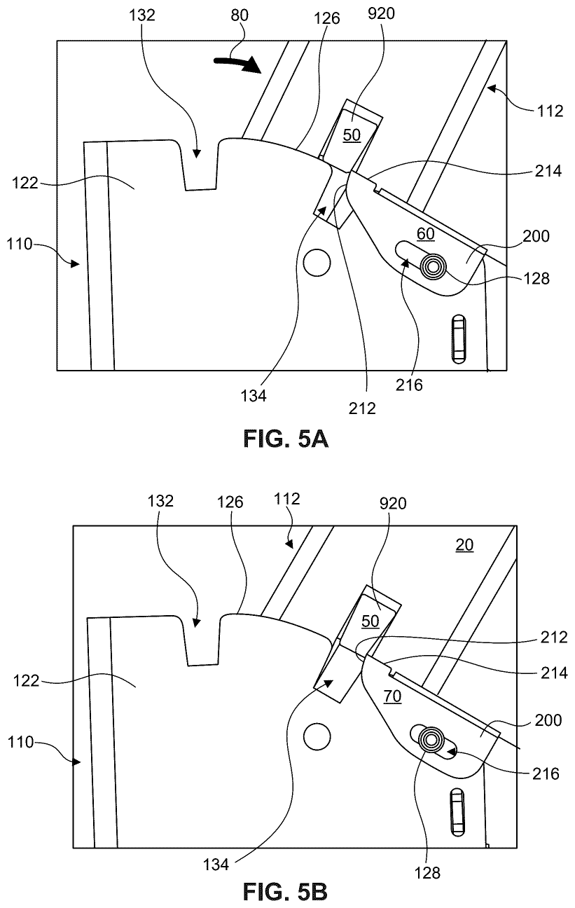

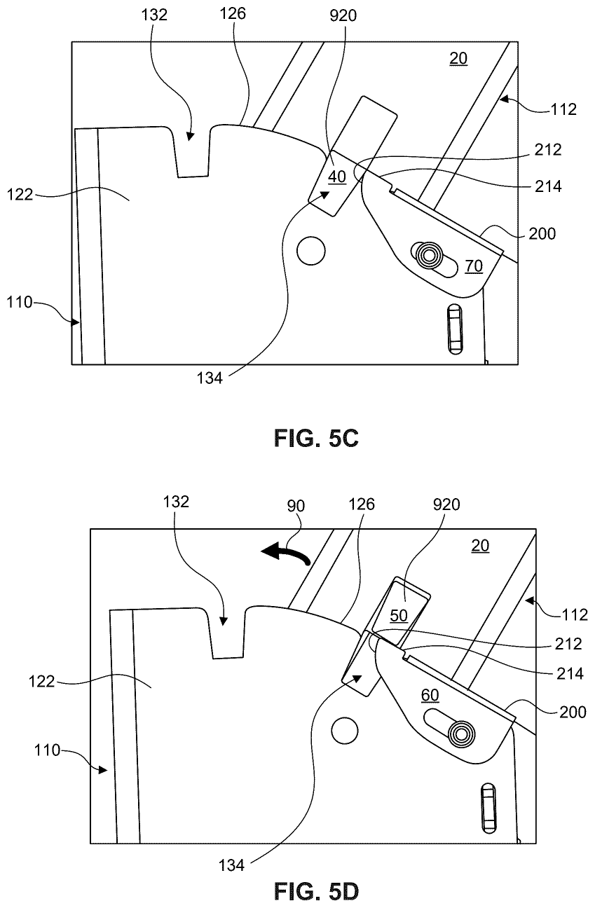

In some embodiments, hub 110 interacts with tilt-release mechanism 900 to lock support member 112 in first position 10 or second position 20, or unlock support member 112 so that support member 112 can move between first and second positions 10, 20. Hub body 122 can include a plurality of recesses 130 formed in an outwardly facing hub surface 126 as shown, for example, in FIGS. 4A-5D. In some embodiments, hub surfaces 126 can extend between first end 140 and second end 142 of channel 124 along the edges of channel 124. Locking arm 920 of tilt-release mechanism 900 is configured to translate from a locked configuration 40 to a released configuration 50 or vice versa. In the locked configuration 40, locking arm 920 can be disposed in one of the plurality of recesses 130. In the released configuration 50, locking arm 920 can be disposed externally to the plurality of recesses 130. In the illustrative embodiment shown in FIG. 5A, locking arm 920 rests on hub surface 126 when support arm is moved between first position 10 and second position 20. Hub surface 126 maintains locking arm 920 in the released configuration 50 during movement of the support member 112 between the first and second positions 10, 20. In some embodiments, locking arm 920 is biased (e.g., by a spring) towards the locked configuration 40. When locking arm 920 approaches one of the plurality of recesses 130, locking arm 920 moves into the recess 130 and into locked configuration 40.

As shown, for example, in FIGS. 4A-5D, plurality of recesses 130 can include first recess 132 and second recess 134. In the illustrative embodiment shown in FIG. 4A, when locking arm 920 is in locked configuration 40 and in first recess 132, support member 112 is locked in first position 10. In the illustrative embodiment shown in FIGS. 4B and 5C, when locking arm 920 is in locked configuration 40 and in second recess 134, support member 112 is locked in second position 20. In the illustrative embodiment shown in FIG. 5A, when support member 112 is moved between the first and second positions 10, 20, locking arm 920 is in released configuration 50 and moves and/or slides along hub surface 126.

Tilt memory actuator 200 can be configured to maintain and/or temporarily hold locking arm 920 in the released configuration 50 after locking arm 920 has been actuated from locked configuration 40 to released configuration 50 as shown, for example in FIGS. 4C and 5D. In some embodiments, tilt memory actuator 200 can be at least partially disposed over one of the plurality of recesses 130 as shown, for example in FIGS. 4C, 5A, and 5D. In some embodiments, tilt memory actuator 200 can completely cover one of the plurality of recesses 130. In some embodiments, tilt memory actuator 200 can be moveably coupled to hub body 122. In some embodiments, tilt memory actuator 200 can couple to support member 112. In some embodiments, tilt memory actuator 200 can couple to locking arm 920. In some embodiments, tilt memory actuator 200 can move from a closed configuration 60 to an open configuration 70 or vice versa. In some embodiments, tilt memory actuator 200 can include guide slot 216, and guide pin 128 of hub 110 can be received within guide slot 216 to guide movement of tilt memory actuator 200. In some embodiments, tilt memory actuator 200 linearly translates from closed configuration 60 to open configuration 70 or vice versa. In some embodiments, tilt memory actuator 200 rotates from closed configuration 60 to open configuration 70 or vice versa. In some embodiments, tilt memory actuator 200 includes a spring 210 that biases tilt memory actuator 200 towards the closed configuration 60. In some embodiments, spring 210 can couple with slots formed in tilt memory actuator 200. In some embodiments, spring 210 can be a torsional spring coupled between hub 110 and tilt memory actuator 200.

Tilt memory actuator 200 can include actuating surface 212 and platform surface 214, as shown, for example, in FIGS. 4A-5D. In the illustrative embodiment shown in FIGS. 5A-5D, when support member 112 is moved in a first direction 80 between first and second positions 10, 20, locking arm 920 moves along and contacts hub surface 126, such that hub surface 126 maintains locking arm 920 in the released configuration 50. As shown, for example, in FIGS. 5A and 5B, platform surface 214 is spaced apart from hub surface 126 such that locking arm 920 contacts actuating surface 212 when locking arm 920 approaches second recess 134. As shown, for example, in FIGS. 5A and 5B, as support member 112 continues to move in first direction 80, into second position 20, locking arm 920 pushes tilt memory actuator 200 away from recess 134 and from closed configuration 60 to open configuration 70.

As shown, for example, in FIGS. 5B and 5C, when tilt memory actuator 200 is in open configuration 70, recess 134 is uncovered. As shown, for example, in FIG. 5C, when tilt memory actuator 200 is in open configuration 70, locking arm 920 can move into recess 134 and into locking configuration 40 to lock support member 112 in second position 20. In some embodiments, locking arm 920 is biased into locked configuration 40 and into recess 134, or another one of the plurality of recesses 130. As shown, for example, in FIGS. 4B and 5C, when locking arm is in locked configuration 40 and disposed in recess 134, locking arm 920 maintains tilt memory actuator 200 in open configuration 70.

When a user desires to move support member 112 in a second direction 90 from second position 20 to first position 10, tilt memory actuator 200 maintains locking arm 920 in released configuration 50. Accordingly, the user does not have to continually and manually actuate locking arm 920 in released configuration 50 as tilt memory actuator 200 automatically performs this function. As shown, for example, in FIGS. 4C and 5D, when locking arm 920 is actuated from locked configuration 40 to released configuration 50, locking arm 920 moves above actuating surface 212 such that tilt memory actuator 200 can move from open configuration 70 to closed configuration 60. As shown, for example, in FIGS. 4C and 5D, tilt memory actuator 200 at least partially covers recess 134 when locking arm 920 moves to released configuration 50. As shown, for example, in FIGS. 4C and 5D, when the user releases actuation of locking arm 920, locking arm 920 rests on and contact platform surface 214 of tilt memory actuator 200. In some embodiments, when platform surface 214 supports locking arm 920 in released configuration 50, support member 112 can freely move in second direction 90 towards first position 10. In some embodiments, locking arm 920 slides over platform surface 214 and onto hub surface 126 before moving into first recess 132 when support member 112 reaches first position 10.

In some embodiments, tilt memory actuator 200 can be positioned over recess 132 such that tilt memory actuator 200 supports locking arm 920 in released configuration 50 above recess 132, and support member 112 can freely move in first direction 80 towards second position 20. When support member 112 is moved in second direction 90 between first and second positions 10, 20, locking arm 920 moves along and contacts hub surface 126 and contacts actuating surface 212 when locking arm 920 approaches first recess 132. In some embodiments, as support member 112 continues to move in second direction 90, into first position 10, locking arm 920 pushes tilt memory actuator 200 away from recess 132 and from closed configuration 60 to open configuration 70.

In some embodiments, when tilt memory actuator 200 is in open configuration 70, recess 132 is uncovered. In some embodiments, when tilt memory actuator 200 is in open configuration 70, locking arm 920 can move into recess 132 and into locking configuration 40 to lock support member 112 in first position 10. In some embodiments, locking arm 920 is biased into locked configuration 40 and into recess 132. In some embodiments, when locking arm 920 is actuated from locked configuration 40 to released configuration 50, locking arm 920 moves above actuating surface 212 such that tilt memory actuator 200 can move from open configuration 70 to closed configuration 60. In some embodiments, tilt memory actuator 200 at least partially covers recess 132 when locking arm 920 moves to released configuration 50. In some embodiments, when the user releases actuation of locking arm 920, locking arm 920 rests on and contact platform surface 214 of tilt memory actuator 200 above recess 132. In some embodiments, when platform surface 214 supports locking arm 920 in released configuration 50, support member 112 can freely move in first direction 80 towards second position 20.

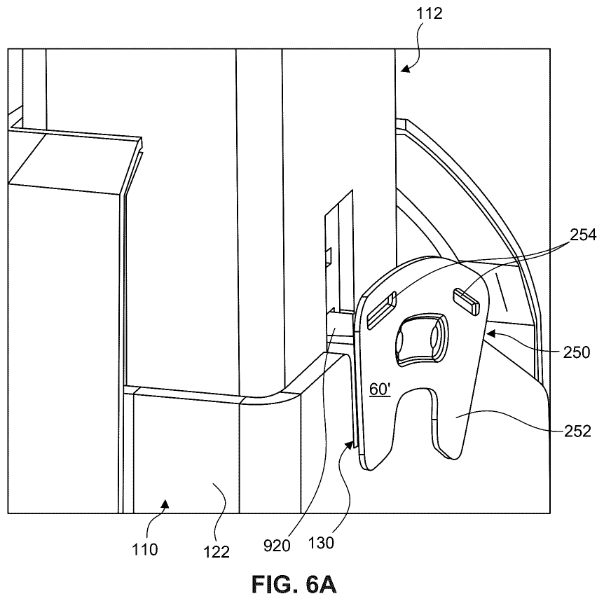

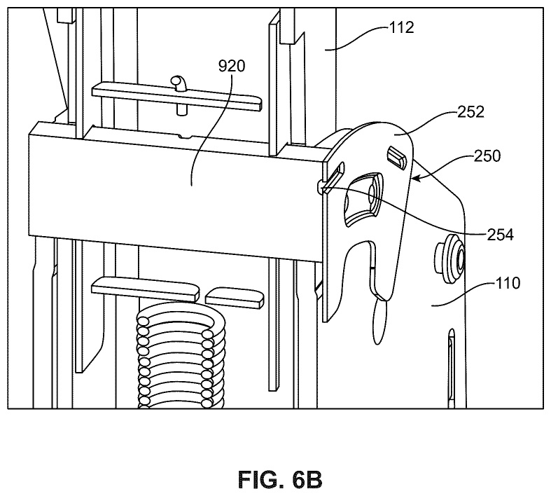

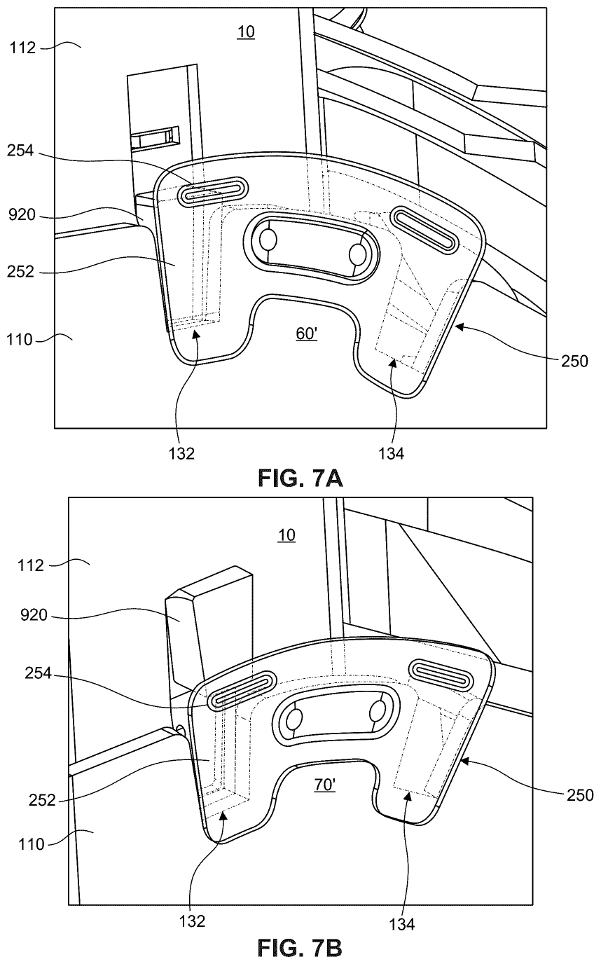

In some embodiments, tilt memory actuator plate 250 can be configured to maintain locking arm 920 in released configuration 50 after locking arm 920 has been actuated from locked configuration 40 to released configuration 50 as shown, for example in FIGS. 6, 7A, and 7B. In some embodiments, tilt memory actuator plate 250 can couple to a side of hub body 122 and extend across the plurality of recesses 130. Tilt memory actuator plate 250 can include plate 252 and protrusions 254. In some embodiments, tilt memory actuator plate 250 can be moveably coupled to hub body 122 from a closed configuration 60′ to an open configuration 70′ or vice versa. In some embodiments, protrusions 254 can extend inwards towards support member 112. In some embodiments, tilt memory actuator plate 252 can include two protrusions 254 disposed over both of recess 132 and recess 134 in closed configuration 60′. As shown, for example, in FIGS. 7A and 7B, when locking arm 920 moves from locked configuration 40 to released configuration 50, locking arm 920 contacts protrusion 254 to bias plate 252 outwardly away from hub 110 to open configuration 70′. In some embodiments, plate 252 moves perpendicular to the movement of locking arm 920. In some embodiments, locking arm 920 and/or protrusion 254 can include chamfers and/or angled edges to facilitate locking arm 920 urging plate 252 into open configuration 70′.

As shown, for example, in FIG. 7B, when locking arm 920 is actuated from locked configuration 40 to released configuration 50, locking arm 920 moves above protrusion 254 such that tilt memory actuator plate 250 moves from open configuration 70′ to closed configuration 60′. As shown, when the user releases actuation of locking arm 920, locking arm 920 rests on and contacts protrusion 254 such that protrusion maintains locking arm 920 in released configuration 50. In some embodiments, when protrusion 254 supports locking arm 920 in released configuration 50, support member 112 can freely move from first position 10 to second position 20 or vice versa. In some embodiments, protrusions 254 can be disposed over recesses 132, 134 to maintain locking arm 920 in released configuration 50 when support member 112 is in the first position 10 or second position 20.

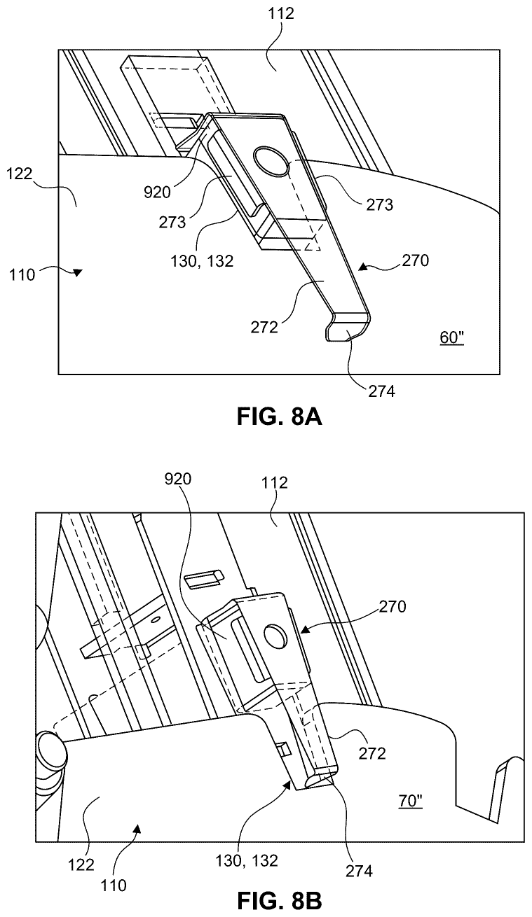

In some embodiments, tilt memory actuator arm 270 can be configured to maintain locking arm 920 in released configuration 50 after locking arm 920 has been actuated from locked configuration 40 to released configuration 50 as shown, for example in FIGS. 8A and 8B. In some embodiments, tilt memory actuator arm 270 can couple to a side of locking arm 920. Tilt memory actuator arm 270 can include a biasing arm 272 and a holding arm 274 extending perpendicularly from biasing arm 272 toward hub body 122. In some embodiments, biasing arm 272 can move holding arm 274 from a closed configuration 60″ to an open configuration 70″ or vice versa. In some embodiments biasing arm 272 can be coupled to locking arm 920 and include side flanges 273 that wrap around a portion of locking arm 920 to maintain the orientation of tilt memory actuator arm 270 relative to locking arm 920. In some embodiments, when locking arm 920 moves to released configuration 50, holding arm 274 is urged by biasing arm 272 into one of the plurality of recesses 130. In some embodiments, holding arm 274 extends into one of the plurality of recesses 130 and contacts a bottom of the recess to maintain locking arm 920 in released configuration 50. In some embodiments, holding arm 274 can include chamfers such that when support member 112 is moved between first and second positions 10, 20, holding arm 274 is urged into the open configuration 70″ by a side face of one of the plurality of recesses 130. In some embodiments, when locking arm 920 is moved to be disposed over a different recess 134, holding arm 274 remains in contact with hub body 122 and in open configuration 70″ such that locking arm 920 can move into recess 134 and into locked configuration 40.

### Example Load Carrier with Hinge Covers

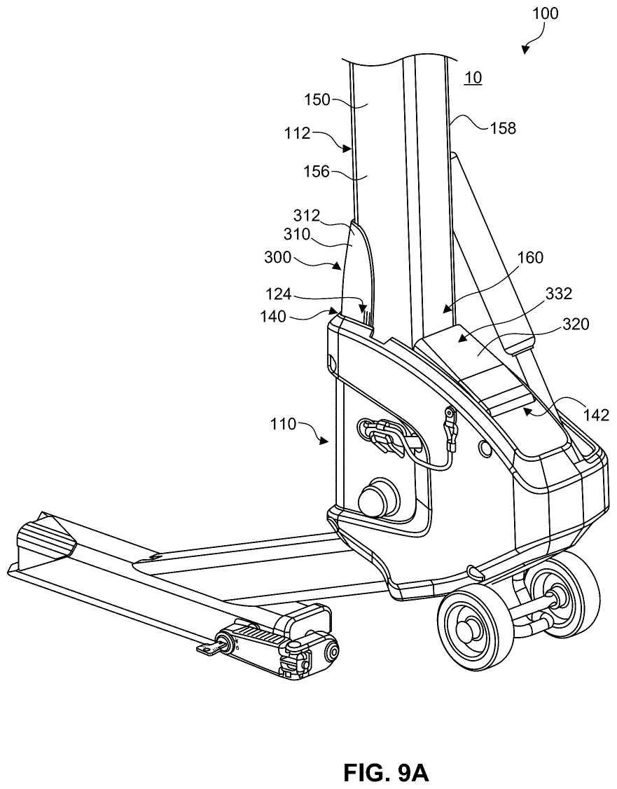

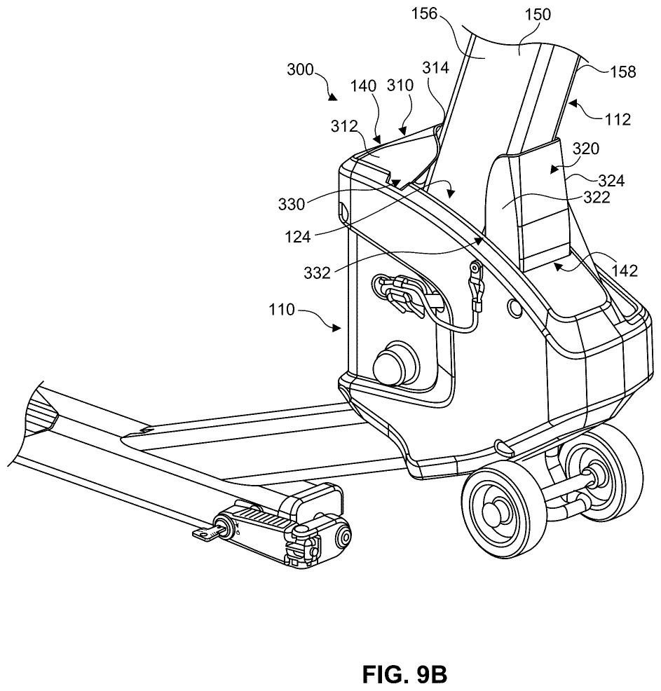

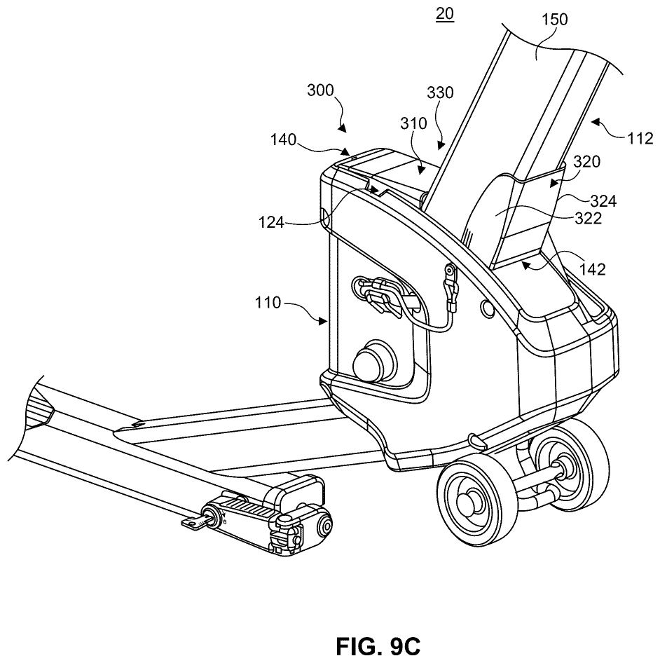

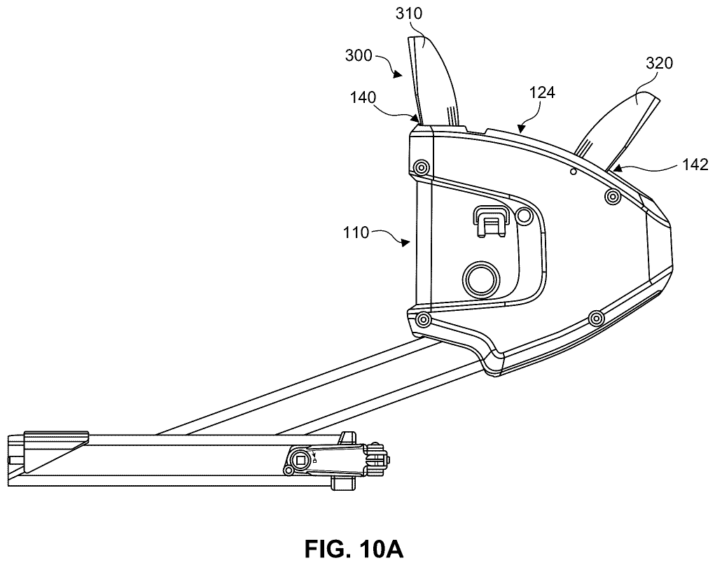

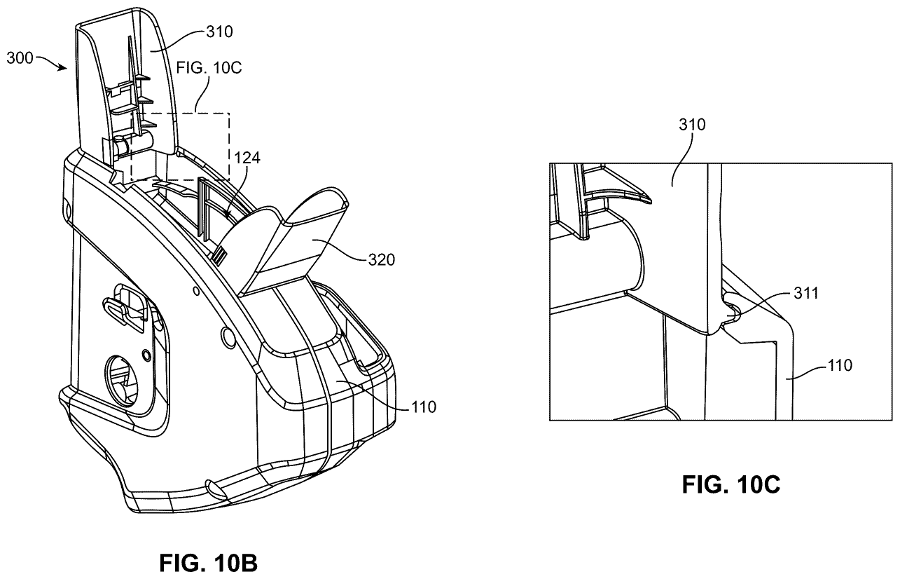

FIGS. 9A-10 illustrate a covers 300 coupled to load carrier system 100, according to embodiments. Covers 300 can be configured to cover an open portion of channel 124 of hub 110 to prevent external objects, including user appendages, from becoming trapped or pinched in channel 124 when support member 112 is moved from first position 10 to second position 20 or vice versa. Although load carrier 100 and covers 300 are shown in FIGS. 9A-10 as a stand-alone system, the embodiments of this disclosure can be used with other apparatuses and/or systems, such as, but not limited to the tilt memory actuator 200, wheel hoop arm 400, wheel insert 500, tilt-assist device 600, strap assembly 700, wheel cradle 800, tilt-release mechanism 900, equipment lock 1000, safety pin 1100, bicycle work stand 1200, wheel support 1300, and/or transport wheel assembly 1400.

As described above, load carrier system 100 can include hub 110 and support member 112 moveably coupled to hub 110. In some embodiments, hub 110 can include channel 124 formed in or by hub body 122. In the illustrative embodiment in FIGS. 9A-9C, support member 112 is disposed in channel 124. In some embodiments, channel 124 can include first end 140 and second end 142. In some embodiments, support member 112 is closer to first end 140 in first position 10 than second end 142. In some embodiments, support member 112 is closer to second end 142 in second position 20 than first end 140. In some embodiments, support member 112 can include first side 156 and second side 158 opposite first side 156. First and second sides 156, 158 extend parallel to the direction 80, 90 of movement of support member 112.

Covers 300 can be configured to cover a portion of channel 124 from support member 112 to first end 140 and from support member 112 to second end 142 as shown, for example, in FIGS. 9A-9C. In some embodiments, covers 300 can prevent access to channel 124 for any position or angle of support member 112 relative to hub 110. In some embodiments, covers 300 may reduce a pinching risk between support member 112 and channel 124. In some embodiments, covers 300 may prevent dirt or debris entering hub 110 via channel 124. In some embodiments, covers 300 can be opened to allow access to channel 124, for example, for assembly of support member 112 to hub 110, as shown, for example, in FIG. 10. In some embodiments, covers 300 can include a protrusion 311 that engages hub 110 to hold covers 300 in the opened configuration (e.g. as shown in FIG. 10). In some embodiments, hub 110 can include a protrusion that engages covers 300 to hold covers in the opened configuration. In some embodiments, covers 300 can be coupled to hub 110. In some embodiments, covers 300 can be coupled to support member 112 and move therewith.

In some embodiments, covers 300 can include first cover 310 and second cover 320 as shown, for example, in FIGS. 9A-10. In some embodiments, first cover 310 covers a first portion 330 of channel 124. In some embodiments, first cover 310 extends from first end 140 of channel 124 to support member 112. In some embodiments, first cover 310 is rotatably coupled to hub 110 at first end 140 of channel 124. In some embodiments, first cover 310 includes an arc shaped slot for rotational movement relative to hub 110. In some embodiments, first cover 310 can be fixedly coupled at first end 140 of channel 124 and translate into pockets formed in support member 112. In some embodiments, first cover 310 can be fixedly coupled to support member 112 and translate into pockets formed in first end 140 of channel 124. In some embodiments, first cover 310 can include a plurality of linearly translating plates, fixed to hub 110 and support member 112, that overlap and slide relative to each other to cover the first portion 330 of channel 124. In some embodiments, first cover 310 can be biased towards support member 112 by a biasing member such as a torsional spring. In some embodiments, first cover 310 can include first sidewall 312 and second sidewall 314 that extend on first and second sides 156, 158 of support member 112 respectively. First and second sidewalls 312, 314 may minimize gaps between first cover 310 and channel 124 as first cover 310 moves with support member 112.

In some embodiments, second cover 320 covers a second portion 332 of channel 124 as shown, for example, in FIGS. 9A-9C. In some embodiments, second cover 320 extends from second end 142 of channel 124 to support member 112. In some embodiments, second cover 320 is rotatably coupled to hub 110 at second end 142 of channel 124. In some embodiments, second cover 320 includes an arc shaped slot for rotational movement relative to hub 110. In some embodiments, second cover 320 can be fixedly coupled at second end 142 of channel 124 and translate into pockets formed in support member 112. In some embodiments, second cover 320 can be fixedly coupled to support member 112 and translate into pockets formed in second end 142 of channel 124. In some embodiments, second cover 320 can include a plurality of linearly translating plates, fixed to hub 110 and support member 112, that overlap and slide relative to each other to cover the second portion 332 of channel 124. In some embodiments, second cover 320 can be biased towards support member 112 by a biasing member such as a torsional spring. In some embodiments, second cover 320 can include first sidewall 322 and second sidewall 324 that extend on first and second sides 156, 158 of support member 112 respectively. First and second sidewalls 322, 324 may minimize gaps between second cover 320 and channel 124 as second cover 320 moves with support member 112.

In the illustrative embodiment shown in FIGS. 9A-9C, support member 112 can move from first position 10 to second position 20, or vice versa, resulting in movement of first and second covers 310, 320 to cover channel 124. In some embodiments, as support member 112 rotates in first direction 80, from first position 10 to second position 20, support member 112 urges movement of second cover 320, while first cover 310 maintains contact with support member 112 via a biasing force and/or gravity. In some embodiments, as support member 112 rotates in second direction 90, from second position 20 to first position 10, support member 112 urges movement of first cover 310, while second cover 320 maintains contact with support member 112 via a biasing force and/or gravity. As shown, for example, in FIG. 9A, first cover 310 is approximately perpendicular to a tangential plane at first end 140 of channel 124 when support member 112 is in first position 10. As shown, second cover 320 is approximately parallel to a tangential plane at second end 142 of channel 124 when support member 112 is in first position 10. As shown, for example, in FIG. 9C, first cover 310 is approximately parallel to a tangential plane at first end 140 of channel 124 when support member 112 is in second position 20. As shown, second cover 320 is approximately perpendicular to a tangential plane at second end 142 of channel 124 when support member 112 is in second position 20. As shown, for example, in FIG. 9B, first and second covers 310, 320 move between a plurality of orientations relative to respective tangential planes at first and second ends 140, 142 of channel 124 when support member is moving between first and second positions 10, 20.

### Example Wheel Hoop Arms and Wheel Inserts

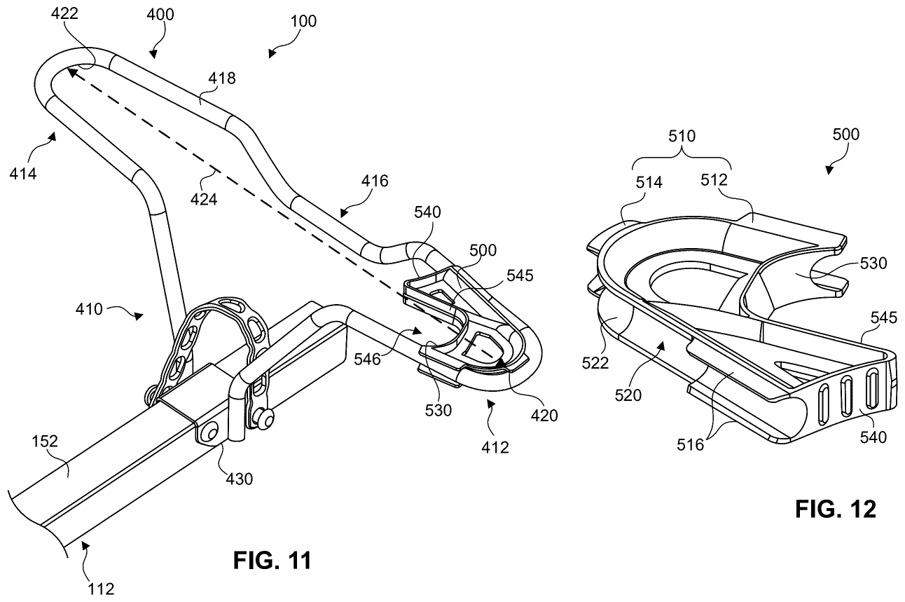

FIGS. 11-13B and 21A-23B illustrate wheel hoop arms 400 coupled to load carrier system 100 and wheel hoop inserts 500 removably coupled to wheel hoop arms 400, according to embodiments. Wheel hoop arms 400 can be configured to secure a first bicycle wheel 106 to load carrier system 100. Wheel hoop inserts 500 can be configured to change (e.g., reduce) a wheel receiving length 434 of wheel hoop arm 400 to accommodate different sized (e.g., smaller) bicycle wheels 106, for example, such as for children's bicycles. Although load carrier 100, wheel hoop arms 400, and wheel hoop inserts 500 are shown in FIGS. 11-13B and 21A-23B as a stand-alone system, the embodiments of this disclosure can be used with other apparatuses and/or systems, such as, but not limited to the tilt memory actuator 200, covers 300, tilt-assist device 600, strap assembly 700, wheel cradle 800, tilt-release mechanism 900, equipment lock 1000, safety pin 1100, bicycle work stand 1200, wheel support 1300, and/or transport wheel assembly 1400.

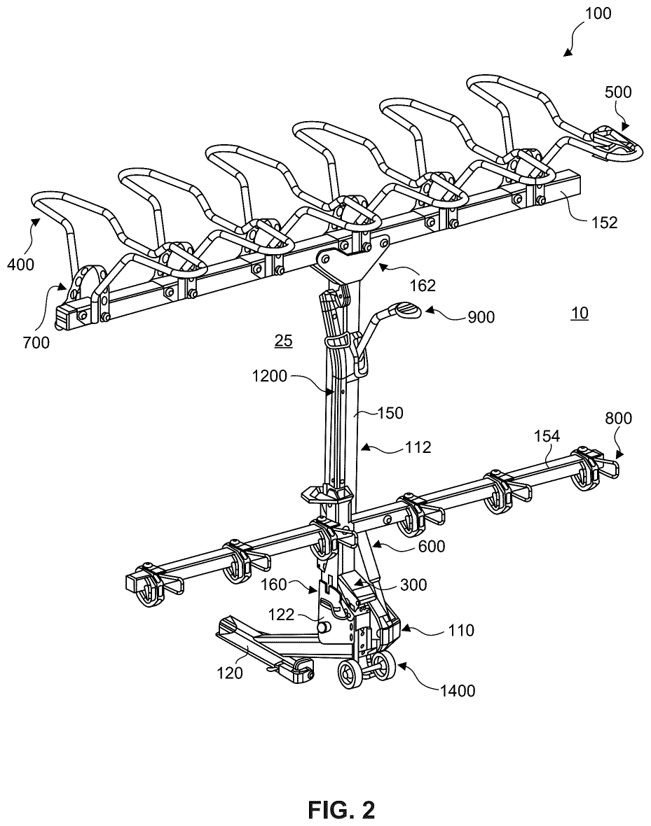

As described above, load carrier system 100 can include support member 112 with vertical support 150, first horizontal support 152, and second horizontal support 154. In the illustrative embodiment shown in FIG. 11, wheel hoop arm 400 is coupled to first horizontal member 152 to secure first bicycle wheel 106 to load carrier system 100. In some embodiments, wheel hoop arm 400 can be coupled to second horizontal support 154 to secure second bicycle wheel 108 to load carrier system 100. In some embodiments, wheel insert 500 can be removably coupled to wheel hoop arm 400 to adjust a wheel receiving length 424 of wheel hoop arm 400. As shown, for example, in FIGS. 1 and 2, a plurality of wheel hoop arms 400 can be coupled to first horizontal support 152. In some embodiments, four wheel hoop arms 400 can be coupled to first horizontal support 152 such that load carrier system 100 can transport four bicycles. In some embodiments, six wheel hoop arms 400 can be coupled to first horizontal support 152 such that load carrier system 100 can transport six bicycles. In some embodiments, less than four or more than six wheel hoop arms 400 can be coupled to first horizontal support 152.

As shown, for example, in FIG. 11, wheel hoop arm 400 can include angled support 410, first coupling portion 412, second coupling portion 414, and recess portion 416. In some embodiments, wheel hoop arm 400 can be made from a continuous single bar, and formed and/or bent into shape. In some embodiments, first coupling portion 412, second coupling portion 414, and recess portion 416 form a perimeter rim 418 of wheel hoop arm 400. In some embodiments, perimeter rim 418 can surround a portion of bicycle wheel 106 and be configured to secure bicycle wheel 106 to load carrier system 100. In some embodiments, wheel hoop arm 400 can have a symmetrical shape.

In some embodiments, angled support 410 extends away from first horizontal support 152 at an acute angle with support 152 as shown, for example, in FIG. 12. In some embodiments, angled support 410 can include two diverging support bars that can be configured to receive a bicycle wheel hub or spokes. In some embodiments, first coupling portion 412 extends away from angled support 410 approximately perpendicular to vertical support 150 and first horizontal support 152. In some embodiments, first coupling portion 412 can include a first end 420 at a distal end from first horizontal support 152. In some embodiments, second coupling portion 414 extends away from angled support 410 approximately perpendicular to vertical support 150 and first horizontal support 152 and opposite first coupling portion 412. In some embodiments, second coupling portion 414 can include a second end 422 at a distal end from first horizontal support 152. In some embodiments, first and second coupling portions 412, 414 can be tapered, v-shaped, u-shaped, or have other appropriate shape for securing bicycle wheel 106. In some embodiments, wheel hoop arm 400 can have wheel receiving length 424 extending from first end 420 of first coupling portion 412 to second end 422 of second coupling portion 414. In some embodiments, wheel receiving length 424 is sized to accommodate a bicycle wheel for regular adult bicycle (e.g. 29″, 27.5″ 650b, 26″, and other typical sizes). In some embodiments, wheel hoop arm 400 can be wider to accommodate a fat tire bicycle wheel. In some embodiments, recess portion 416 extends between first and second coupling portions 412, 414 on an opposite side of wheel hoop arm 400 to angled support 410. In some embodiments, recess portion 416 extends toward first horizontal support 152 to form a dipped portion of wheel hoop arm 400. In some embodiments, recess portion 416 can be configured to provide space for a bicycle wheel hub or spokes, to avoid contact with these components against perimeter rim 418.

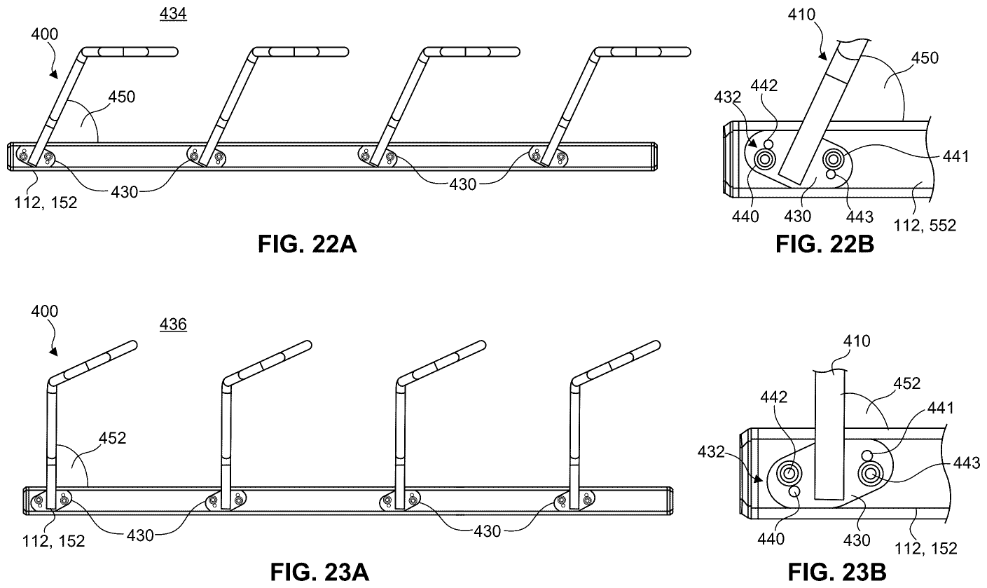

Angled support 410 can couple to first horizontal support 152 at a plurality of angles 450, 452 to adjust an angle and orientation of wheel hoop arm 400 relative to first horizontal support 152. In some embodiments, angled support 410 can include coupling bracket 430 to couple with first horizontal support 152. In the illustrative embodiment shown in FIGS. 22A-23B, coupling bracket 430 can include a plurality of angle position apertures 432. An angle and orientation 434, 436 of wheel hoop arm 400 can be adjusted based on the apertures 432 used to couple coupling bracket 430 to first horizontal support 152. As shown, for example, in FIGS. 22A and 22B, when first and second apertures 440, 441 are used, wheel hoop arm 400 has first orientation 434 with first angle 450 relative to first horizontal support 152. As shown, for example, in FIGS. 23A and 23B, when third and fourth apertures 442, 443 are used, wheel hoop arm 400 has second orientation 436 with second angle 452 relative to first horizontal support 152. In some embodiments, combinations of first and fourth apertures 440, 443, or second and third apertures 441, 442 may provide additional orientations of wheel hoop arm 400 relative to first horizontal support 152.

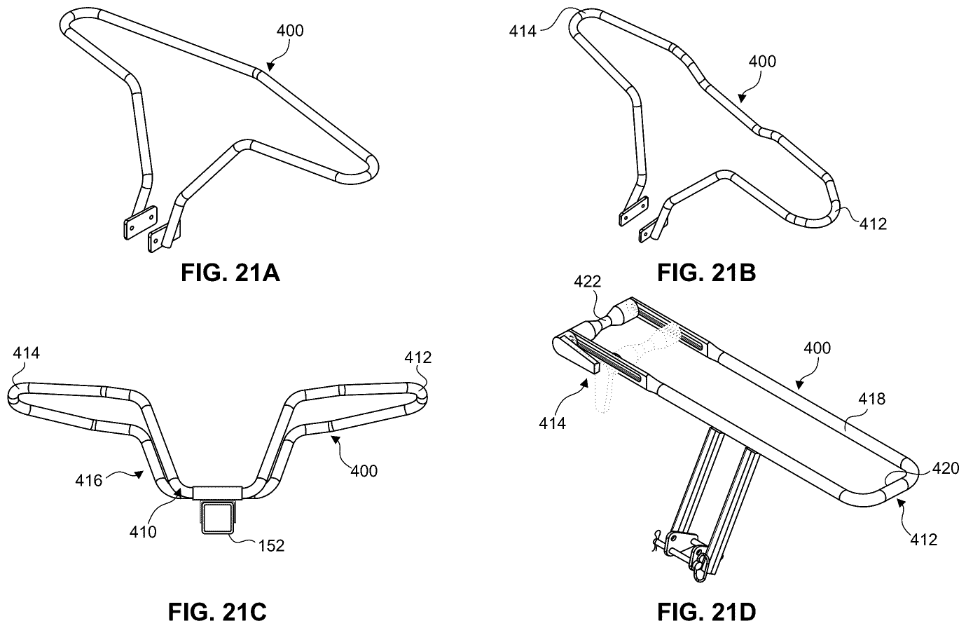

Wheel hoop arm 400 can have different shapes and sizes. In some embodiments, wheel hoop arm 400 can have a wider profile without recess portion 416 as shown, for example, in FIG. 21A. In some embodiments, first and second coupling portions 412, 414 can be asymmetrical, for example, with first coupling portion 412 being wider than second coupling portion 414 as shown, for example, in FIG. 21B. In some embodiments, recess portion 416 can extend to and couple with first horizontal support 152, and wheel hoop arm 400 can be formed from a continuous bar through all portions 410, 412, 414, 416 as shown, for example, in FIG. 21C. In the illustrative embodiment shown in FIG. 21C, angled support 410 and recess portion 416 can be slideably coupled to first horizontal support 152. In some embodiments, angled support 410 and recess portion 416 can be moved relative to one another to change a size of wheel hoop arm 400, for example, to widen or shorten wheel hoop arm 400. In some embodiments, perimeter rim 418 can rotate relative to coupling bracket 430 to adjust an angle of wheel hoop arm 400 relative to first horizontal support 152. In some embodiments, first or second coupling portions 412, 414 can include slots such that first or second ends 420, 422 can slide along perimeter rim 418 to adjust wheel receiving length 424 as shown, for example, in FIG. 21D.

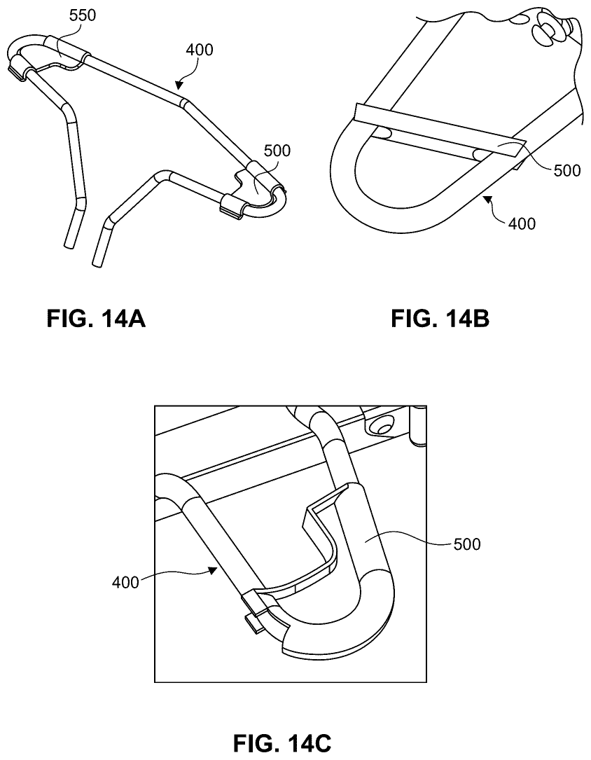

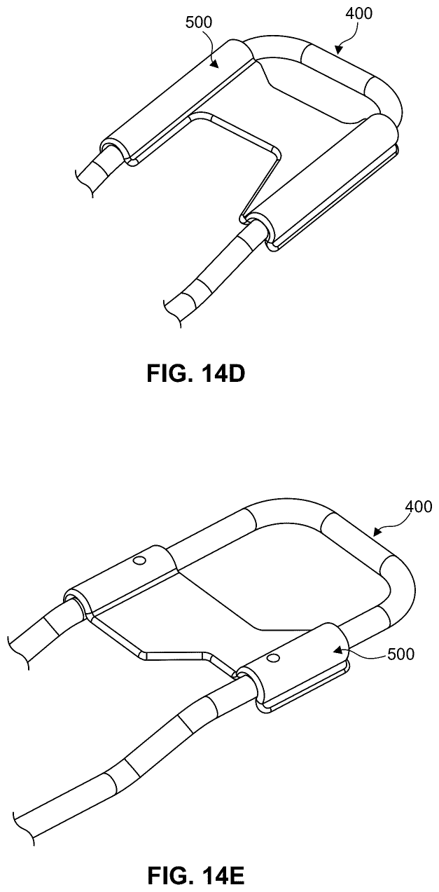

In some embodiments, wheel insert 500 can be removably coupled with wheel hoop arm 400. In some embodiments, wheel insert 500 can be configured to reduce wheel receiving length 424 of wheel hoop arm 400. As shown, for example, in FIGS. 11 and 12, wheel insert 500 can include a plurality of flanges 510, outer wall 520, first support edge 530, second support edge 540, and/or wall 545 extending from first support edge 530 to second support edge 540. In some embodiments, wheel insert 500 can be removably coupled to first coupling portion 412 of wheel hoop arm 400. In some embodiments, wheel insert 500 can be removably coupled to second coupling portion 414 of wheel hoop arm 400. In some embodiments, wheel insert 500 can be removably coupled to first coupling portion 412 and a second wheel insert 550 can be removably coupled to second coupling portion 414 of wheel hoop arm 400 as shown, for example, in FIG. 14A.

In some embodiments, one or more of the plurality of flanges 510 are configured to receive and detachably couple with perimeter rim 418 of wheel hoop arm 400. In some embodiments, plurality of flanges 510 can include first flange 512, second flange 514, and third flange 516 as shown, for example, in FIGS. 11 and 12. In some embodiments, wheel insert 500 can include less than three flanges. In some embodiments, wheel insert 500 can include more than three flanges. In some embodiments, all flanges 512, 514, 516 form a snap-fit connection with wheel hoop arm 400. In some embodiments, only one or two flanges of the plurality of flanges form a snap-fit connection with wheel hoop arm, while the remaining flanges rest on wheel hoop arm 400 to maintain positioning of wheel insert 500 relative to wheel hoop arm 400. For example, flanges 514, 516 can form a snap-fit connection with wheel hoop arm 400, with flange 512 guiding or preventing rotation of wheel insert 500 relative to wheel hoop arm 400. In some embodiments, outer wall 520 extends around a perimeter rim 418 facing portion of wheel insert 500. In some embodiments, outer wall 520 can have a concave profile 522 that matches the profile of perimeter rim 418 to form a close fit therebetween. In some embodiments, outer wall 520 can include a different profile 522 to match the profile of perimeter rim 418.

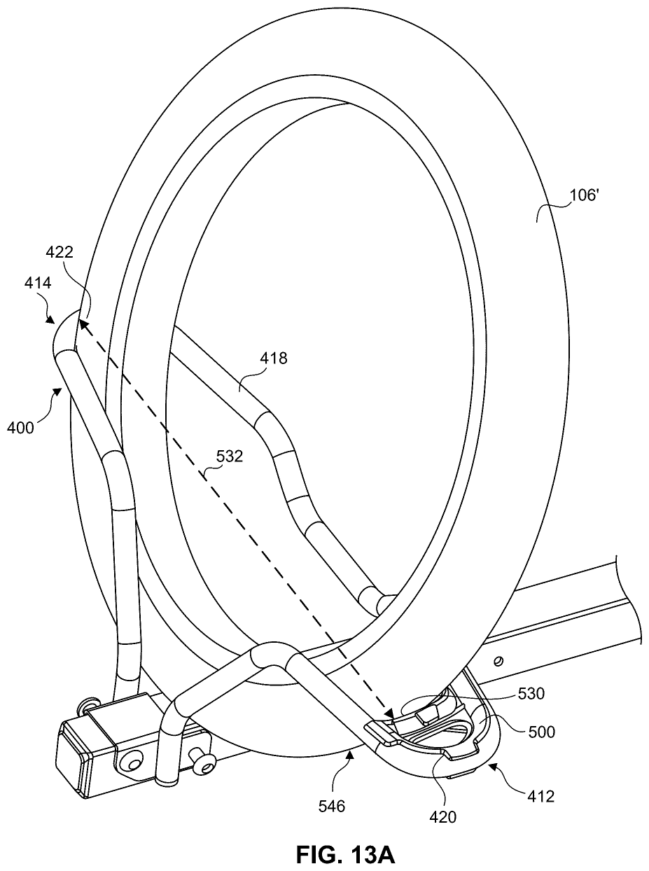

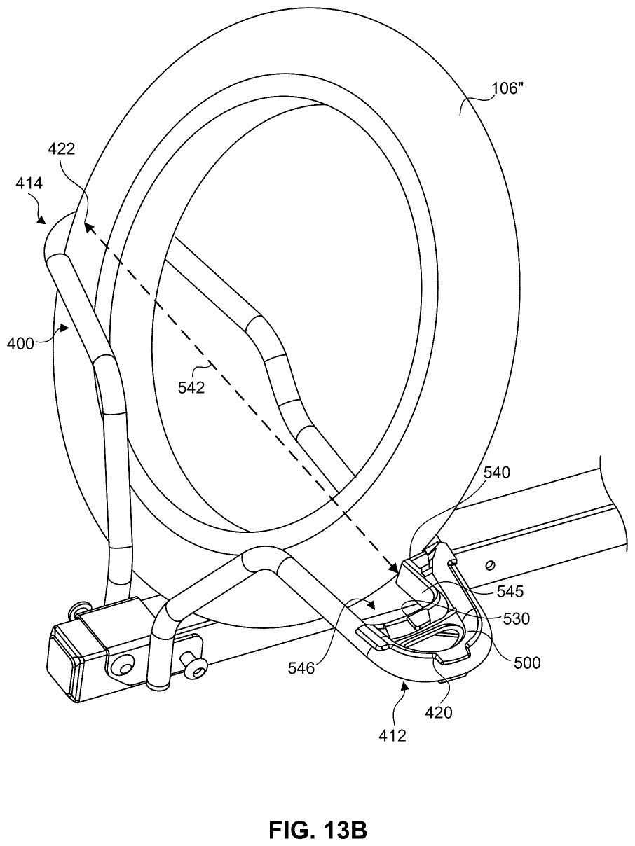

In some embodiments, first support edge 530 can extend inward toward the receiving space of wheel hoop arm 400 as shown, for example, in FIG. 11. In some embodiments, first support edge 530 forms a first reduced wheel receiving length 532 less than wheel receiving length 424. In some embodiments, first reduced wheel receiving length 532 extends from first support edge 530 to second end 422 of wheel hoop arm 400. Wall 545 extends from first support edge 530 to second support edge 540. In some embodiments, a wheel receiving channel 546 is formed between perimeter rim 418, first support edge 530, and wall 545. In some embodiments, a wheel receiving channel 546 is configured to receive a bicycle wheel 106′. As shown, for example, in FIG. 13A, first support edge 530 can be configured to secure bicycle wheel 106′ with a first reduced diameter (e.g. 24″ children's bicycle wheel). In some embodiments, second support edge 540 can extend inward toward the receiving space of wheel hoop arm 400 as shown, for example, in FIG. 11. In some embodiments, second support edge 540 is spaced further apart from first end 420 than first support edge 530. In some embodiments, second support edge 540 forms a second reduced wheel receiving length 542 less than first reduced wheel receiving length 532 and wheel receiving length 424. In some embodiments, second reduced wheel receiving length 542 extends from second support edge 540 to second end 422 of wheel hoop arm 400. As shown, for example, in FIG. 13B, second support edge 540 can be configured to secure a bicycle wheel 106″ with a second reduced diameter less than bicycle wheel 106′ with first reduced diameter (e.g. 20″ children's bicycle wheel).

In some embodiments, wheel insert 500 can have different shapes and sizes. In some embodiments, wheel insert 500 can include two flanges that extend around an upper portion of perimeter rim 418 as shown, for example, in FIG. 14A. In some embodiments, wheel insert 500 can be a linear bar that diagonally extends across first coupling portion 412 as shown, for example, in FIG. 14B. In some embodiments, wheel insert 500 can include a flange that extend around an upper portion of perimeter rim 418 and around the u-shaped portion of first coupling portion 412 as shown, for example, in FIG. 14C. In some embodiments, wheel insert 500 can be a reversible insert that provides first wheel receiving length when installed in a first direction, and provides a second wheel receiving length when installed in an opposite direction as shown, for example, in FIGS. 14D and 14E.

### Example Tilt-Assist Device

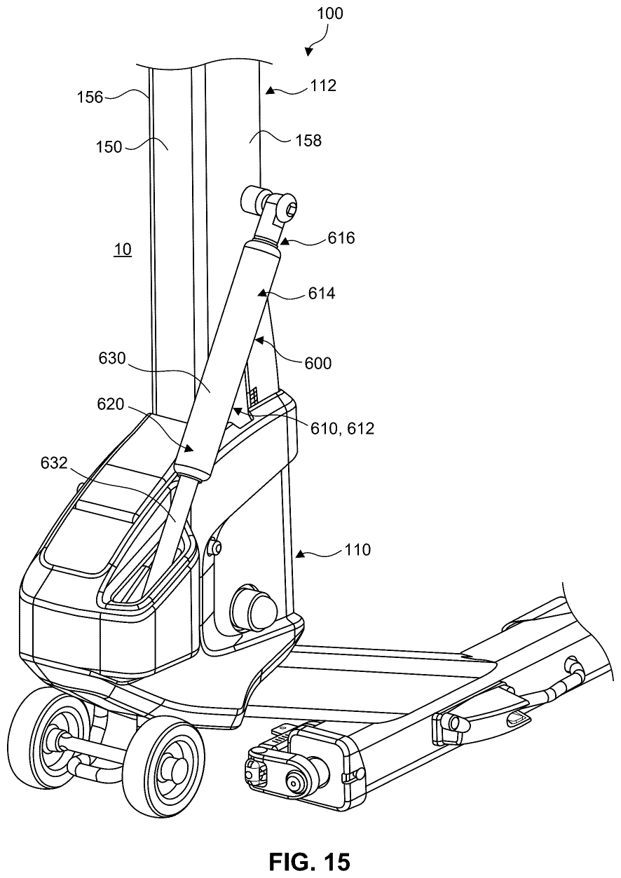

FIGS. 15-20C illustrate a tilt-assist device 600 coupled to load carrier system 100, according to embodiments. Tilt-assist device 600 can be configured to control a rate of movement of support member 112 and/or assist in lifting support member 112 from second position 20 to first position 10, or vice versa. Although load carrier 100 and tilt-assist device 600 are shown in FIGS. 15-20C as a stand-alone system, the embodiments of this disclosure can be used with other apparatuses and/or systems, such as, but not limited to the tilt memory actuator 200, covers 300, wheel hoop arm 400, wheel insert 500, strap assembly 700, wheel cradle 800, tilt-release mechanism 900, equipment lock 1000, safety pin 1100, bicycle work stand 1200, wheel support 1300, and/or transport wheel assembly 1400.

As described above, load carrier system 100 can include hub 110 and support member 112 having first and second sides 156, 158. In some embodiments, support member 112 can be moveably coupled to hub 110 from first position 10 to second position 20 or vice versa. In the illustrative embodiment shown in FIG. 15, tilt-assist device 600 can couple to hub 110 and support member 112. In some embodiments, tilt-assist device 600 can be arranged on and coupled to second side 158 of support member 112. In some embodiments, tilt-assist device 600 can be configured to support, control, and assist movement of support member 112 relative to hub 110. In some embodiments, tilt-assist device 600 can reduce vibration in load carrier system 100 when load carrier system 100 is being transported, for example, on the back of a vehicle. In some embodiments, tilt-assist device 600 can provide bump control and suspension between hub 110 and support member 112 to suppress vibration in the load carrier system 100 when load carrier system 100 is transported.

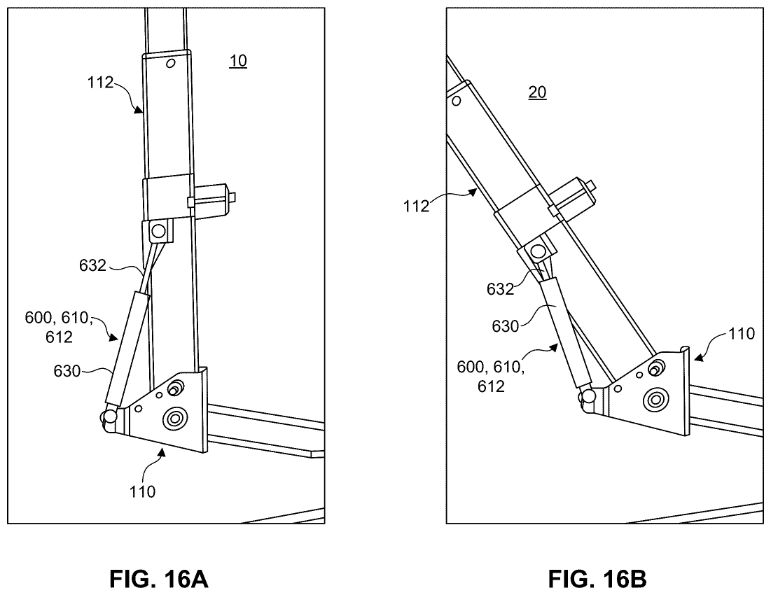

In some embodiments, load carrier system 100 can secure heavy equipment, for example, a plurality of bicycles 102, 104. In some embodiments, gravity may assist in moving support member 112 from first position 10 to second position 20. However, when the equipment secured to load carrier system 100 is heavy, it can overwhelm a user and support member 112 may move too quickly. Accordingly, tilt-assist device 600 can control the rate of movement or rotation of support member 112 relative to hub 110. Similarly, if the equipment secured to load carrier system 100 is heavy, a user may struggle to move support member 112 against gravity and the weight of the equipment from second position 20 to first position 10. Accordingly, tilt-assist device 600 may assist the lifting operation to move support member 112 relative to hub 110. In some embodiments, tilt-assist device 600 is in a compressed state when support member 112 is in first position 10. In some embodiments, tilt-assist device 600 is in a compressed state when support member 112 is in second position 20 as shown, for example, in FIG. 16B. In some embodiments, tilt-assist device 600 is in an extended state when support member 112 is in first position 10 as shown, for example, in FIG. 16A. In some embodiments, tilt-assist device 600 is in an extended state when support member 112 is in second position 20.

In some embodiments, tilt-assist device 600 can include a damping unit 610 and a spring unit 612. In some embodiments, tilt-assist device 600 can include damping unit 610 or spring unit 612. In some embodiments, damping unit 610 and spring unit 612 can be a single unit. In some embodiments, damping unit 610 can control a rate of movement or rotation of support member 112 relative to hub 110. In some embodiments, damping unit 610 can be adjusted to change the rate of rotation of support member 112. In some embodiments, damping unit 610 can be configured to slow rotation of support member 112 relative to hub 110, for example, when support member 112 approaches first position 10 or second position 20. In some embodiments, damping unit 610 can be configured to slow rotation of support member 112 relative to hub 110 when support member 112 is between about 5 degrees to 15 degrees from the first position 10 and/or the second position 20. In some embodiments, damping unit 610 can be configured to not slow rotation of support member 112 relative to hub 110 until support member 112 is between about 5 degrees to 15 degrees from the first position 10 and/or the second position 20.

In some embodiments, damping unit 610 can be adjusted based on the weight of the equipment secured to load carrier system 100. In some embodiments, damping unit 610 can automatically adjusted based on the weight of the equipment or the speed of movement of the support member 112 from the first position 10 to the second position 20. In some embodiments, damping unit 610 can be configured to adjust a rate of rotation of support member 112 at different positions between and including first position 10 and second position 20. In some embodiments, damping unit 610 can be configured to adjust a time for support member 112 to travel between first and second positions 10, 20. For example, damping unit 610 may control movement of support member 112 to travel between first and second positions 10, 20 about 5 seconds. In some embodiments, damping unit 610 may control movement of support member 112 to travel between first and second positions 10, 20 in more than about 2 seconds and less than about 10 seconds. In some embodiments, damping unit 610 may control movement of support member 112 to travel between first and second positions 10, 20 in more than about 3 seconds and less than about 7 seconds

In some embodiments, damping unit 610 can include user controls such that a user can adjust the damping properties of damping unit 610 to achieve desired rotation speeds throughout the movement of support member 112 between first and second positions 10, 20. In some embodiments, damping unit 610 and spring unit 612 can automatically adjust a damping rate or force based on the load (e.g., the weight) secured to load carrier system 100. In some embodiments, tilt-assist device 600 can include an additional damping reservoir or chamber (e.g. a piggyback reservoir) to provide improved control and adjustability of damping unit 610 and spring unit 612. In some embodiments, tilt-assist device 600 can include a sensor and/or processor configured to detect loads, vibration, and/or user inputs, and adjust properties of the damping unit 610 and spring unit 612 in response.

In some embodiments, spring unit 612 can provide a desired amount of force to assist moving support member 112 from second position 20 to first position 10. In some embodiments, spring unit 612 can include a coil spring. In some embodiments, spring unit 612 can be a gas spring 614. In some embodiments, the amount of gas in gas spring 614 can be changed to adjust a force provided to assist movement of support member 112. In some embodiments, gas spring 614 can include an actuator 616 that exerts force to assist movement of support member 112 when actuator 616 is operated. In some embodiments, damping unit 610 can work with spring unit 612 to control the rate of movement or rotation of support member 112 from second position 20 to first position 10. In some embodiments, tilt-assist device 600 can include a sensor 620 that detects a weight of equipment secured to the load carrier system 100, and adjusts damping unit 610 and/or spring unit 612 based on the detected load. In some embodiments, damping unit 610 and/or spring unit 612 can include a housing 630 and a rod 632 that extends within housing 630. In some embodiments, housing 630 can couple to support member 112 and rod 632 can couple to hub 110. In some embodiments, housing 630 can couple to hub 110 and rod 632 can couple to support member 112 as shown, for example in FIGS. 16A and 16B.

In some embodiments, spring unit 612 provides a force to support member 112 from the first position 10 to the second position 20 and vice versa. In some embodiments, damping unit 610 is only active in an action zone near the first position 10 and/or the second position 20. In some embodiments, the action zone is between about 1 degrees and 20 degrees (e.g., between about 5 degrees and 15 degrees) from the first position 10 and/or the second position 20. In some embodiments, the action zone near the first position 10 is equal to the action zone near the second position 20. In some embodiments, the action zone near the first position 10 is different compared to the action zone near the second position 20.

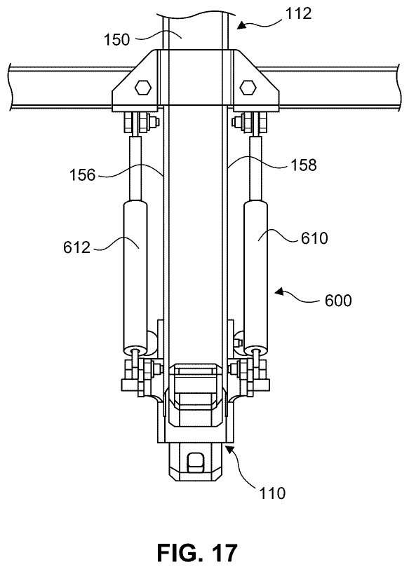

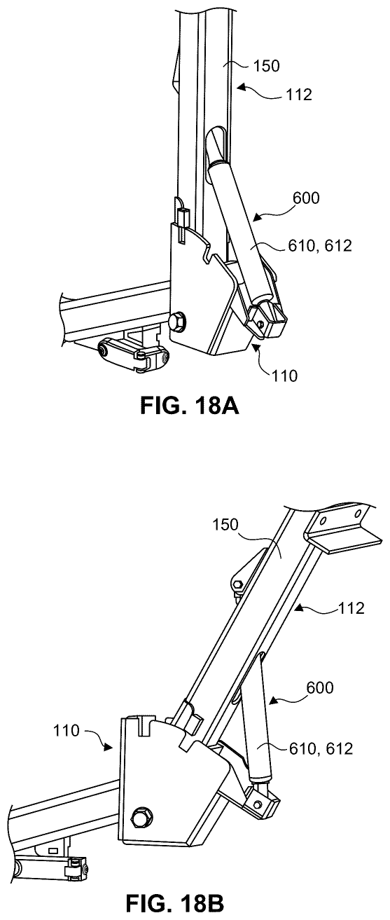

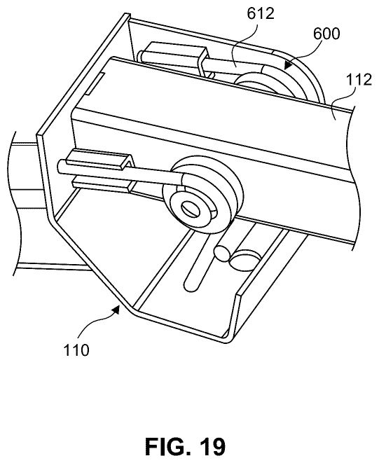

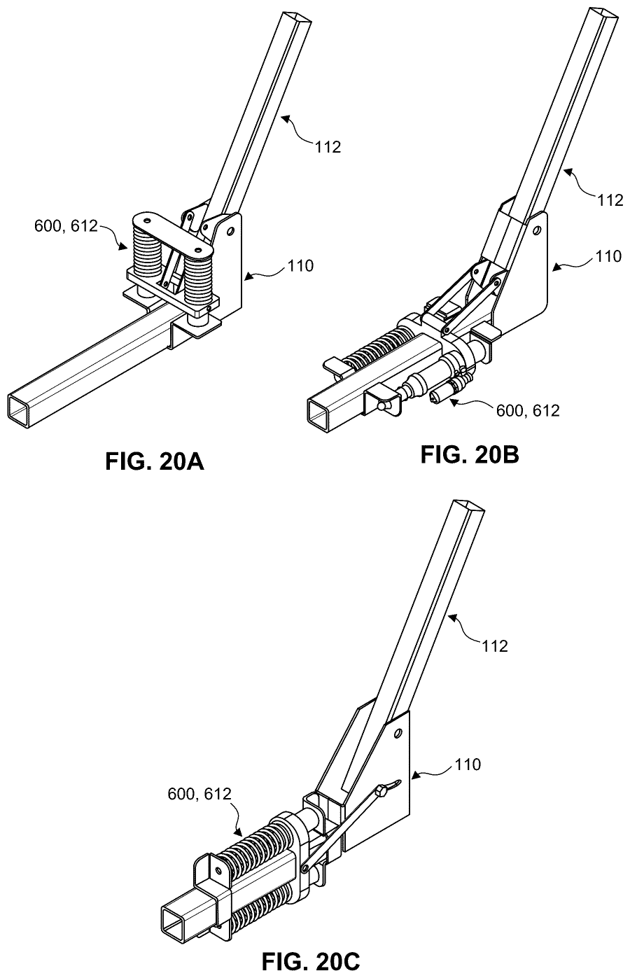

In some embodiments, damping unit 610 can be arranged on first side 156 of support member and spring unit 612 can be arranged on second side 158 of support member 112 as shown, for example, in FIG. 17. In some embodiments, a separate damping unit 610 and separate spring unit 612 can be arranged in parallel on the same side 156, 158 of support member 112. In some embodiments, support member 112 can include an aperture formed through support member 112, and tilt-assist device 600 can extend through support member 112 as shown, for example, in FIGS. 18A and 18B. In some embodiments, spring unit 612 can be a torsional spring and can be arranged within hub 110 as shown, for example, in FIG. 19. In some embodiments, spring unit 612 can include a pair of springs disposed between plates and arranged in a plurality of positions on load carrier system 100 as shown, for example, in FIGS. 20A-20C.

### Example Strap Assembly

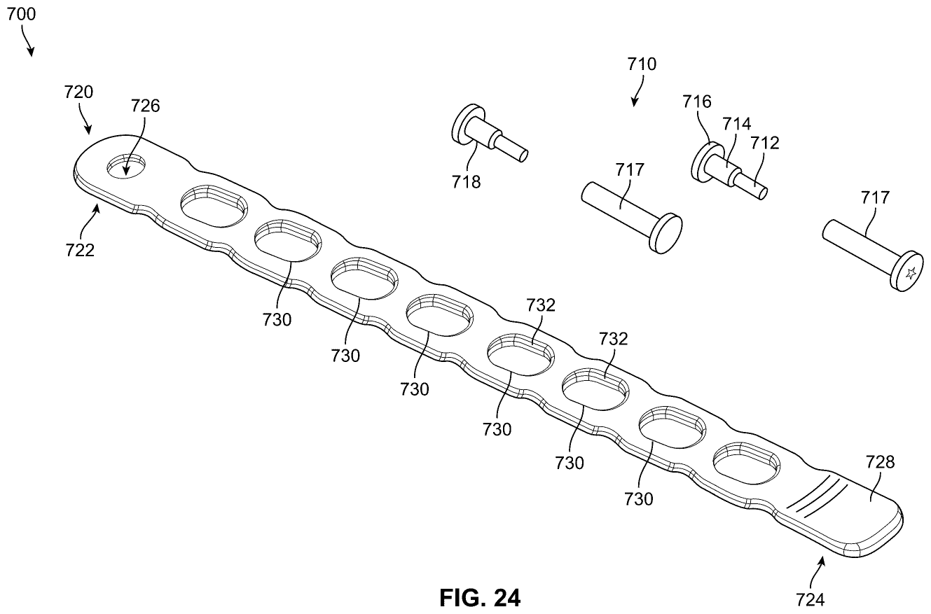

FIGS. 24-26 illustrate a strap assembly 700, according to embodiments. Strap assembly 700 can be configured to secure a bicycle wheel 106 to load carrier system 100. Although strap assembly 700 is shown in FIGS. 24-26 as a stand-alone system, the embodiments of this disclosure can be used with other apparatuses and/or systems, such as, but not limited to the tilt memory actuator 200, covers 300, wheel hoop arm 400, wheel insert 500, tilt-assist device 600, wheel cradle 800, tilt-release mechanism 900, equipment lock 1000, safety pin 1100, bicycle work stand 1200, wheel support 1300, and/or transport wheel assembly 1400.

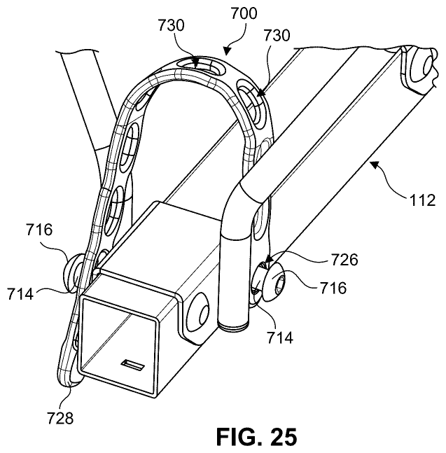

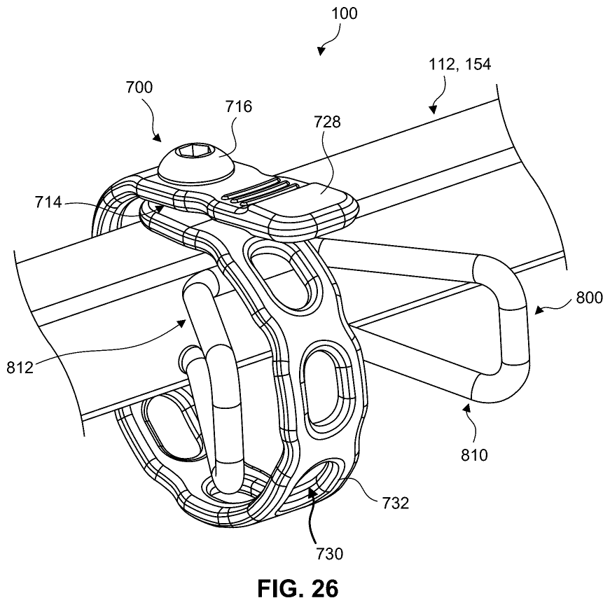

In some embodiments, strap assembly 700 can include a protruding bolt 710 and a strap 720. Strap assembly 700 can be coupled with support member 112 to secure bicycle wheel 106 and/or bicycles 102, 104 to load carrier system 100. In some embodiments, strap assembly 700 can be coupled to wheel hoop arm 400 or wheel cradle 800 as shown, for example, in FIGS. 25 and 26. In the illustrative embodiment shown in FIG. 24, protruding bolt 710 can include a coupling shaft 712, a spacing shaft 714, and a bolt head 716. In some embodiments, spacing shaft 714 is disposed between coupling shaft 712 and bolt head 716. In some embodiments, bolt head 716 is spaced apart from support member 112 by spacing shaft 714. In some embodiments, coupling shaft 712 can couple to and be fixed with support member 112. In some embodiments, coupling shaft 712 can be secured to support member 112 with a fastener 717, such as a nut, or a hollow bolt with internal threads. In some embodiments, spacing shaft 714 and/or fastener 717 can have a square cross-sectional shape 718. In some embodiments, spacing shaft 714 and bolt head 716 can be a separate spacer component and secured to support member 112 with a fastener that extends through the spacer component.

In the illustrative embodiment shown in FIG. 24, strap 720 can include a first end 722, a second end 724 opposite first end 722, and a plurality of apertures 730 formed through strap 720. In some embodiments, first end 722 can include coupling aperture 726 formed through first end 722 and configured to couple with protruding bolt 710 and/or support member 112. In some embodiments, second end 724 can include grip portion 728 for a user to pull. In some embodiments, one or more of the plurality of apertures 730 can include a counter sunk surface, edge, or flange. In some embodiments, one or more of the plurality of apertures 730 can be elongated with round corners. In some embodiments, strap 720 can be made from an elastic material (e.g., rubber, polymer(s), TPE, etc.) and can be stretched to be tightly pulled around equipment secured with strap assembly 700. In some embodiments, strap 720 can be removably coupled with protruding bolt 710 such that an aperture of the plurality of apertures 730 is arranged around spacing shaft 714 and disposed between bolt head 716 and support member 112.

### Example Wheel Cradle

FIG. 26 illustrates a wheel cradle 800 coupled to support member 112, according to embodiments. Wheel cradle 800 can be configured to secure a wheel (e.g., second wheel 108) to load carrier system 100. Wheel cradle 800 can work with wheel hoop arm 400 to secure bicycle 102 to load carrier system 100. Although load carrier 100 and wheel cradle 800 are shown in FIG. 26 as a stand-alone system, the embodiments of this disclosure can be used with other apparatuses and/or systems, such as, but not limited to the tilt memory actuator 200, covers 300, wheel hoop arm 400, wheel insert 500, tilt-assist device 600, strap assembly 700, tilt-release mechanism 900, equipment lock 1000, safety pin 1100, bicycle work stand 1200, wheel support 1300, and/or transport wheel assembly 1400.

As described above, load carrier system 100 can include support member 112 having vertical support 150, first horizontal support 152, and second horizontal support 154. In the illustrative embodiment shown in FIG. 26, wheel cradle 800 can coupled to second horizontal support 154 and be configured to secure bicycle wheel 108 to load carrier system 100. In some embodiments, wheel cradle 800 can include wheel receiving end 810 and coupling portion 812. In some embodiments coupling portion 812 can couple to second horizontal support 154 (e.g. with fastener(s) or by welding). In some embodiments, wheel cradle 800 can be formed or bent from a bar of material (e.g., metal). In some embodiments, wheel cradle 800 can have an approximately triangular shape. In some embodiments, wheel cradle 800 can taper from wheel receiving end 810 to coupling portion 812.

### Example Tilt-Release Mechanism

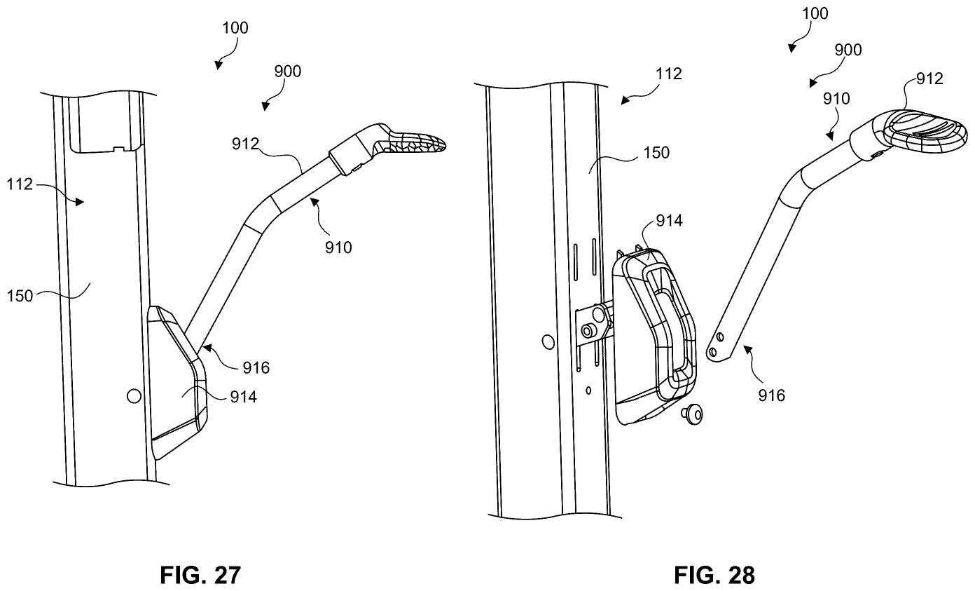

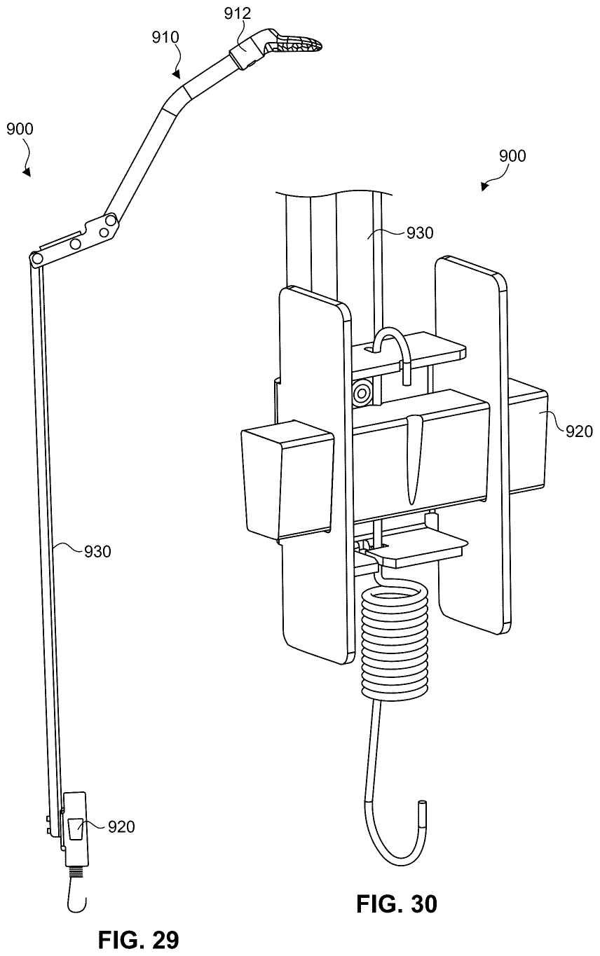

FIGS. 27-30 illustrate a tilt-release mechanism 900 coupled to load carrier system 100, according to embodiments. Tilt-release mechanism 900 can be configured to lock support member 112 relative to hub 110 and unlock support member 112 so that support member 112 can move relative to hub 110. Although load carrier 100 and tilt-release mechanism 900 are shown in FIGS. 27-30 as a stand-alone system, the embodiments of this disclosure can be used with other apparatuses and/or systems, such as, but not limited to the tilt memory actuator 200, covers 300, wheel hoop arm 400, wheel insert 500, tilt-assist device 600, strap assembly 700, wheel cradle 800, equipment lock 1000, safety pin 1100, bicycle work stand 1200, wheel support 1300, and/or transport wheel assembly 1400.

As described above, load carrier system 100 can include hub 110 and support member 112. In some embodiments, hub 110 can include a plurality of recesses 130 formed in hub 110. In some embodiments, support member 112 can include first end 160 moveably coupled to hub 110 and second end 162 opposite first end 160. In some embodiments, hub 110 interacts with tilt-release mechanism 900 to lock support member 112 in first position 10 or second position 20, or unlock support member 112 so that support member 112 can move from first position 10 to second position 20 or vice versa. In some embodiments, tilt-release mechanism can include actuator 910, locking arm 920, and/or linkage 930 as shown, for example in FIGS. 27-30. In some embodiments, linkage 930 can couple actuator 910 to locking arm 920 and transfer movement of actuator 910 to locking arm 920. In some embodiments, linkage 930 can be disposed within vertical support 150 of support member 112. In some embodiments, linkage 930 can be a wire, chain, cord, rod, elongated plate, or tube.

In the illustrative embodiment shown in FIG. 27, actuator 910 can rotatably couple to support member 112. In some embodiments, actuator 910 can be a lever, handle, wire, strap, or telescopic arm. In some embodiments, actuator 910 can be disposed along support member 112 between first end 160 and second end 162. In some embodiments, actuator 910 can be spaced apart from first end 160 and second end 162. In some embodiments, actuator 910 can be a button, lever, knob, or strap. In some embodiments, actuator 910 can be disassembled from support member 112 to reduce a footprint when transporting load carrier system 100 as shown, for example, in FIG. 28. In some embodiments, cover 914 can be disposed around a coupling end 916 of actuator 910 to hide and protect mechanical linkages and couplings (e.g. with rivets or bolts) of tilt-release mechanism 900. In some embodiments, when actuator 910 is operated, locking arm 920 moves (e.g., translates) out of one of the plurality of recesses 130 to released configuration 50 such that support member 112 can move relative to hub 110.

In some embodiments, locking arm 920 can be configured to translate from a locked configuration 40 to a released configuration 50 or vice versa as shown, for example, in FIGS. 4A-5D. In the locked configuration 40, locking arm 920 can be disposed in one of the plurality of recesses 130. In the released configuration 50, locking arm 920 can be disposed externally to the plurality of recesses 130. In some embodiments, locking arm 920 is biased towards the locked configuration 40. When locking arm 920 approaches one of the plurality of recesses 130, locking arm 920 moves into the recess 130 and into locked configuration 40.

### Example Equipment Lock

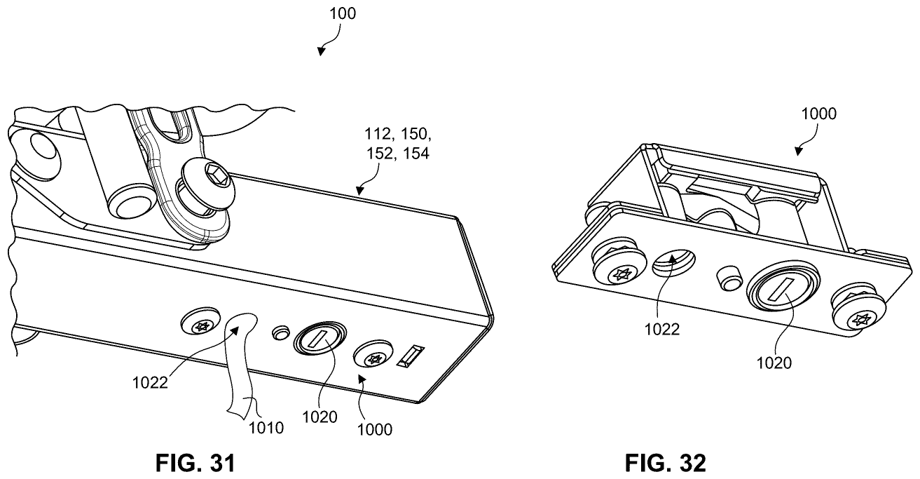

FIGS. 31 and 32 illustrate an equipment lock 1000, which can be integrated into load carrier system 100, according to embodiments. In some embodiments, equipment lock 1000 can be configured to lock a cable 1010 to load carrier system 100. Cable 1010 can be arranged around or through components of bicycles 102, 104 that are secured to load carrier system 100 to lock bicycles 102, 104 to load carrier system 100. In some embodiments, cable 1010 can be arranged around and/or through a load or sports equipment secured to a load carrier system 100. Although equipment lock 1000 is shown in FIGS. 31 and 32 as a stand-alone system, the embodiments of this disclosure can be used with other apparatuses and/or systems, such as, but not limited to the tilt memory actuator 200, covers 300, wheel hoop arm 400, wheel insert 500, tilt-assist device 600, strap assembly 700, wheel cradle 800, tilt-release mechanism 900, safety pin 1100, bicycle work stand 1200, wheel support 1300, and/or transport wheel assembly 1400.

As described above, load carrier system 100 can include support member 112 having vertical support 150, first horizontal support 152, and second horizontal support 154. In some embodiments, equipment lock 1000 can be integrated into a distal end of vertical support 150, first horizontal support 152, and/or second horizontal support 154 such that equipment lock 1000 can be easily accessible to a user when bicycles 102 or loads are secured to load carrier system 100. In some embodiments, equipment lock 1000 can be integrated into first horizontal support 152 adjacent to wheel hoop arm 400. In some embodiments, equipment lock 1000 can be integrated into second horizontal support 154 adjacent to wheel cradle 800. In some embodiments, barrel aperture 1020 and locking device aperture 1022 are formed through first horizontal support 152 as shown, for example, in FIG. 31.

Cable 1010 can be locked to equipment lock 1000. Cable can include a loop on one end and a locking notch at the opposite end. In some embodiments, load carrier system 100 can include a storage bag for storing cable 1010 when not in use. In some embodiments, cable 1010 can be stored in a hollow cavity within support member 112 when not in use. In some embodiments, cable 1010 can be coupled to a recoil device coupled to support member 112. Recoil device can be configured to recoil cable 1010 to neatly store cable 1010 when not in use. In some embodiments, cable 1010 can be configured to extend around a portion of bicycle 102 or other load secured to load carrier system 100 to lock said bicycle 102 or load to load carrier system 100.

### Example Safety Pin

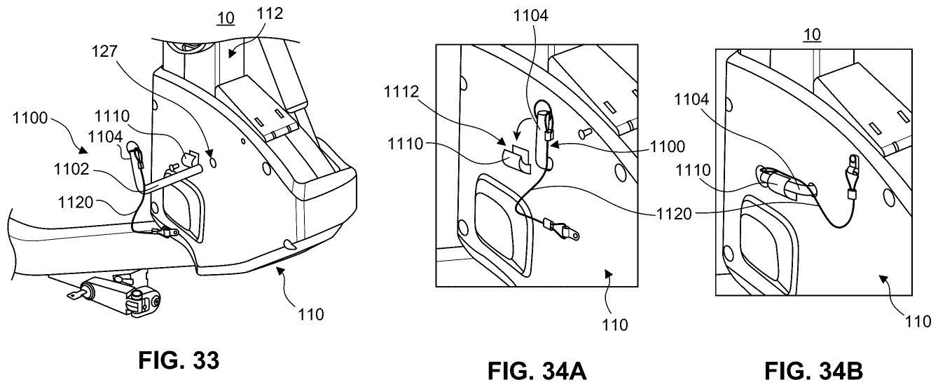

FIGS. 33-34B illustrate a safety pin 1100 configured to prevent movement of support member 112 relative to hub 110, according to embodiments. In some embodiments, safety pin 1100 can be secured to a pin cradle 1110 when load carrier system 100 is in transport to secure safety pin 1100 to hub 110. Although safety pin 1100 is shown in FIGS. 33-34B as a stand-alone system, the embodiments of this disclosure can be used with other apparatuses and/or systems, such as, but not limited to the tilt memory actuator 200, covers 300, wheel hoop arm 400, wheel insert 500, tilt-assist device 600, strap assembly 700, wheel cradle 800, tilt-release mechanism 900, equipment lock 1000, bicycle work stand 1200, wheel support 1300, and/or transport wheel assembly 1400.

As described above, load carrier system 100 can include hub 110 and support member 112. In some embodiments, support member 112 can be moveably coupled to hub 110 from a first position 10 to second position 20 or vice versa. In some embodiments, when support member 112 is in first position 10, safety pin 1100 can be inserted through an aperture 127 in hub 110 to prevent support member 112 from moving to second position 20. This may be important when load carrier system 100 is being transported and support member 112 needs to be in first position 10 to avoid damaging equipment and the load carrier system 100. In the illustrative embodiment shown in FIG. 33, safety pin 1100 can include shaft 1102 and handle 1104. In some embodiments, shaft 1102 can extend through aperture 127 in hub 110 to prevent support member 112 from moving. In some embodiments, handle 1104 can extend perpendicular to shaft 1102 and be disposed externally to hub 110. In some embodiments, safety pin 1100 is L-shaped.

In the illustrative embodiment shown in FIGS. 33, 34A, and 34B, hub 110 can include pin cradle 1110. In some embodiments, pin cradle 1110 can couple to hub 110 with fasteners. In some embodiments, pin cradle 1110 can be integrally formed with hub 110. In some embodiments pin cradle 1110 can form at least a portion of a receiving space 1112 for safety pin 1100. Receiving space 1112 can be configured to receive and secure safety pin 1100 when safety pin 1110 is inserted into aperture 127 of hub 110. In some embodiments, safety pin 1100 can be inserted into hub 110 and safety pin 1110 can be rotated through 90 degrees and received in receiving space 1112 as shown, for example, in FIGS. 34A and 34B. In some embodiments, handle 1104 can couple with a snap-fit connection to pin cradle 1110. In some embodiments, pin cradle 1110 can be configured to receive safety pin 1100 when safety pin is not disposed through aperture 127 of hub 110. In some embodiments, safety pin 1100 can include a safety wire 1120 to fixedly couple safety pin 1100 to hub 110.

### Example Bicycle Work Stand

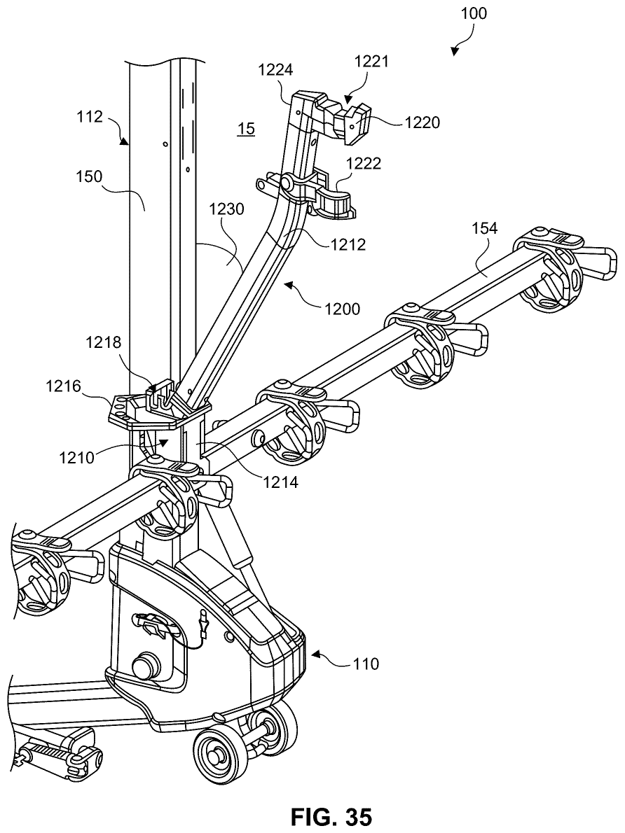

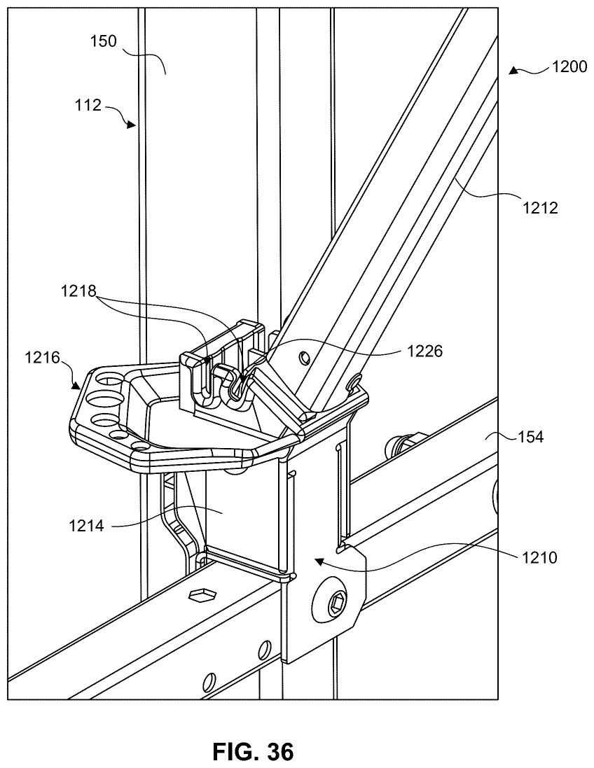

FIGS. 35 and 36 illustrate a bicycle work stand 1200 coupled to support member 112 on load carrier system 100, according to embodiments. Bicycle work stand 1200 can be configured to support a bicycle 102 in an upright position when bicycle 102 is not secured to load carrier system 100 with wheel hoop arms 400. Although load carrier 100 and bicycle work stand 1200 are shown in FIGS. 35 and 36 as a stand-alone system, the embodiments of this disclosure can be used with other apparatuses and/or systems, such as, but not limited to the tilt memory actuator 200, covers 300, wheel hoop arm 400, wheel insert 500, tilt-assist device 600, strap assembly 700, wheel cradle 800, tilt-release mechanism 900, equipment lock 1000, safety pin 1100, wheel support 1300, and/or transport wheel assembly 1400.

As described above, load carrier system 100 can include support member 112 having vertical support 150 and second horizontal support 154. In some embodiments, bicycle work stand 1200 can be pivotally coupled to support member 112 as shown, for example, in FIGS. 35 and 36. In some embodiments, bicycle work stand 1200 can couple to vertical support 150. In some embodiments, bicycle work stand 1200 can couple to second horizontal support 154. Bicycle work stand 1200 can be pivoted from an in-use position 15 to a stowed position 25 (as shown in FIG. 2), or vice versa, and can include a base joint 1210, a support arm 1212, a first support 1220, and/or a second support 1222, as shown, for example, in FIG. 35. Support arm 1212 can be pivotally coupled to support member 112 via base joint 1210 and can extend away from support member at an in-use angle 1230 such that bicycle 102 is spaced apart from support member 112 when bicycle 102 is supported by bicycle work stand 1200. In some embodiments, in-use angle 1230 is approximately 30 degrees. In some embodiments, in-use angle 1230 is between approximately 10 degrees and 60 degrees.

In some embodiments, base joint 1210 can couple to support member 112 and pivotally couple to support arm 1212, as shown, for example, in FIGS. 35 and 36. In some embodiments, base joint 1210 can be removably coupled to support member 112. In some embodiments, base joint 1210 can couple to second horizontal support 154 adjacent to vertical support 150. In some embodiments, base joint 1210 can couple to a distal end of second horizontal support 154. Base joint 1210 can include a housing 1214, a tool tray 1216, and a plurality of recesses 1218. Housing 1214 can extend outwardly away from support member 112 in the direction support arm 1212 pivots and behind load carrier system 100. An aperture can be formed through housing 1214 and be configured to receive support arm 1212. Plurality of recesses 1218 can be formed in housing 1214 and configured to receive support arm protrusion 1226. Engagement between protrusions 1226 and recesses 1218 can maintain bicycle work stand 1200 in either the in-use position 15 or the stowed position 25. In some embodiments, tool tray 1216 can be an arm, a hook, a loop, or similar shape, such that a bag or tools can be hung from tool tray 1216.

In some embodiments, first support 1220 couples to a distal end 1224 of support arm 1212 and can be configured to secure a saddle component of bicycle 102. In the illustrative embodiment shown in FIG. 35, first support 1220 can include a stepped groove 1221 configured to accommodate different shapes and sizes of saddles and corresponding saddle rails and seat-post attachment flanges, or other suitable bicycle components. In some embodiments, first support 1220 can have U-shape, V-shape, or any other shape that corresponds to a component of a bicycle.

In some embodiments, second support 1222 can couple to support arm 1212 and can be spaced apart from first support 1220. In the illustrative embodiment shown in FIG. 35, second support 1222 can be hingedly coupled to support arm 1212. In some embodiments, a U-shaped groove can be formed in second support 1222 and configured to accommodate a seat-post or a seat tube of the frame of the bicycle 102, or other suitable component or feature of a bicycle. In some embodiments, second support 1222 can have V-shape, square shape, or any other shape that corresponds to a component or frame feature of a bicycle.

In some embodiments, support arm 1212 translates and pivots around base joint 1210 to move bicycle work stand 1200 from the in-use position 15 to the stowed position 25 or vice versa. To move bicycle work stand 1200 from the in-use position 15 to the stowed position 25, support arm 1212 can be pulled upward and outward from support member 112 such that a pivot pin translates along a slot in support arm 1212. Movement of support arm 1212 can also translate protrusion 1226 out of a first recess of the plurality of recesses 1218, such that support arm 1212 can pivot around pivot pin toward the stowed position 25. When support arm 1212 reaches the stowed position 25, support arm 1212 can be translated downward such that protrusion 1226 extends into a second recess of the plurality of recesses 1218 to hold support arm in the stowed position 25.

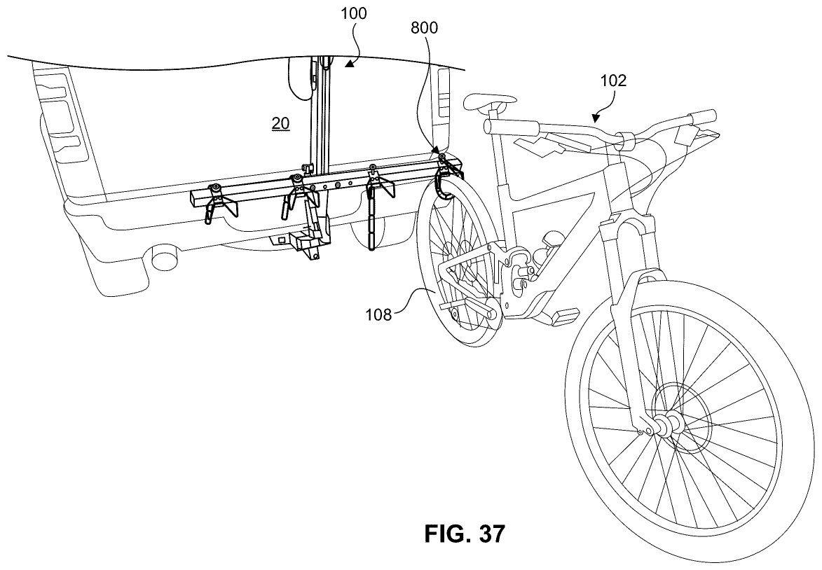

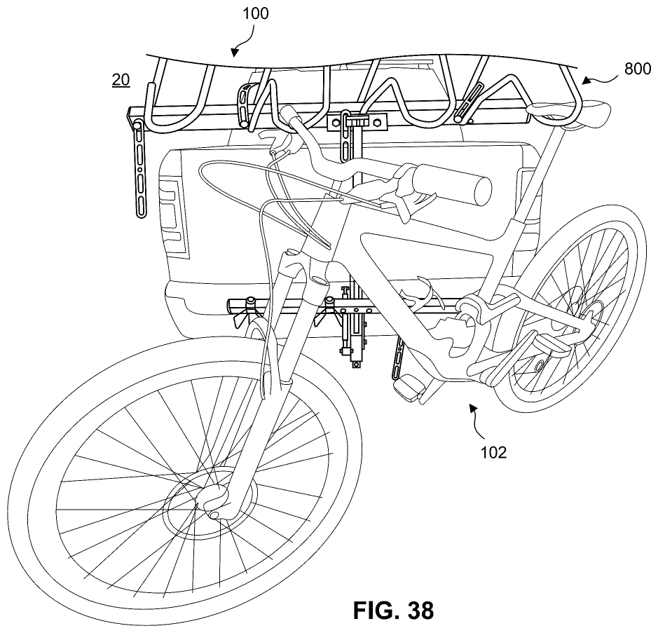

In some embodiments, wheel cradle 800 can be used to support bicycle 102 in the upright position by securing bicycle wheel 108 in wheel cradle 800 when load carrier system 100 is in second position 20 as shown, for example, in FIG. 37. In some embodiments, wheel hoop arm 400 can be used to support bicycle 102 in the upright position by supporting a saddle of bicycle 102 when load carrier system 100 is in second position 20 as shown, for example, in FIG. 38.

### Example Wheel Hoop Arm Corner Support

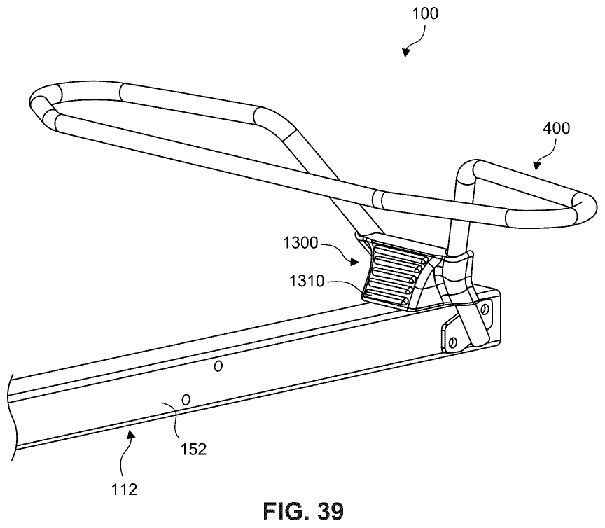

FIG. 39 illustrates a wheel hoop arm corner support 1300 coupled between wheel hoop arm 400 and support member 112, according to embodiments. Corner support 1300 can be configured to provide additional support to bicycle wheel 106 when bicycle wheel 106 is secured in wheel hoop arm 400. Although wheel hoop arm corner support 1300 is shown in FIG. 39 as a stand-alone system, the embodiments of this disclosure can be used with other apparatuses and/or systems, such as, but not limited to the tilt memory actuator 200, covers 300, wheel hoop arm 400, wheel insert 500, tilt-assist device 600, strap assembly 700, wheel cradle 800, tilt-release mechanism 900, equipment lock 1000, safety pin 1100, bicycle work stand 1200, and/or transport wheel assembly 1400.

As described above, load carrier system 100 can include support member 112 having first horizontal support 152 and wheel hoop arm 400 coupled to first horizontal support 152. In the illustrative embodiment shown in FIG. 39, wheel support 1300 can be releasably coupled to wheel hoop arm 400 and contact and/or rest on first horizontal support 152. Wheel support 1300 can be angled towards perimeter rim 418 such that when bicycle wheel 106 is secured in wheel hoop arm 400, bicycle wheel 106 is stabilized by wheel support 1300. In some embodiments, wheel support 1300 can be wedge shaped or triangular shaped. In some embodiments, wheel support 1300 can be made from plastic and molded. In some embodiments, wheel support 1300 includes ribs 1310 to facilitate gripping with bicycle wheel 106. In some embodiments, wheel support 1300 is removably coupled with a snap-fit connection to wheel hoop arm 400 to avoid movement of wheel support 1300. In some embodiments, wheel support 1300 can be reversible such that when wheel hoop arm 400 is assembled at a different orientation 434, 436, wheel support 1300 can still releasably couple to wheel hoop arm 400.

### Example Transport Wheels

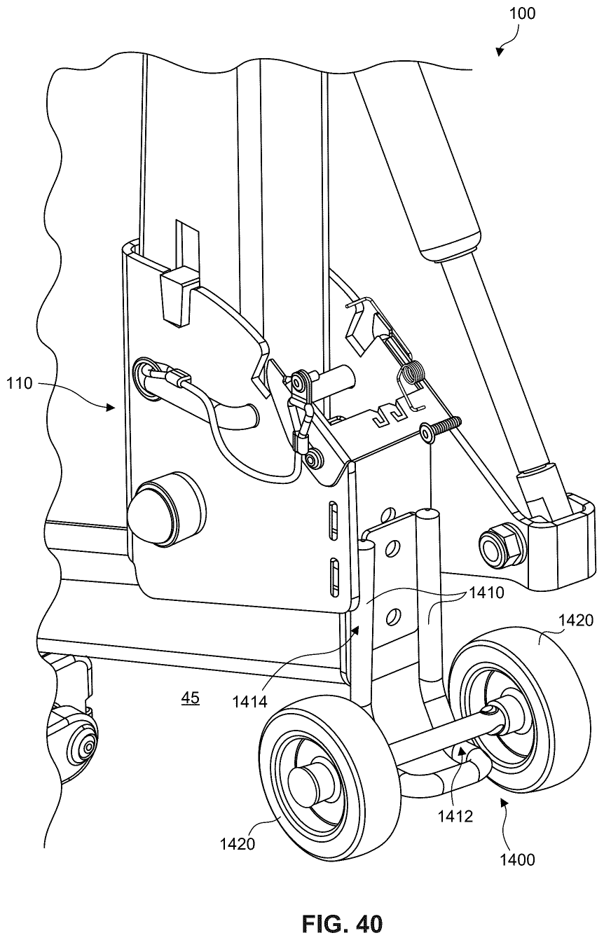

FIGS. 40-42 illustrate a transport wheel assembly 1400 coupled to load carrier system 100, according to embodiments. Wheel assembly 1400 can be configured to position wheels 1420 in a transport position 45 and a storage position. Although load carrier 100 and transport wheel assembly 1400 are shown in FIGS. 40-42 as a stand-alone system, the embodiments of this disclosure can be used with other apparatuses and/or systems, such as, but not limited to the tilt memory actuator 200, covers 300, wheel hoop arm 400, wheel insert 500, tilt-assist device 600, strap assembly 700, wheel cradle 800, tilt-release mechanism 900, equipment lock 1000, safety pin 1100, bicycle work stand 1200, and/or wheel support 1300.

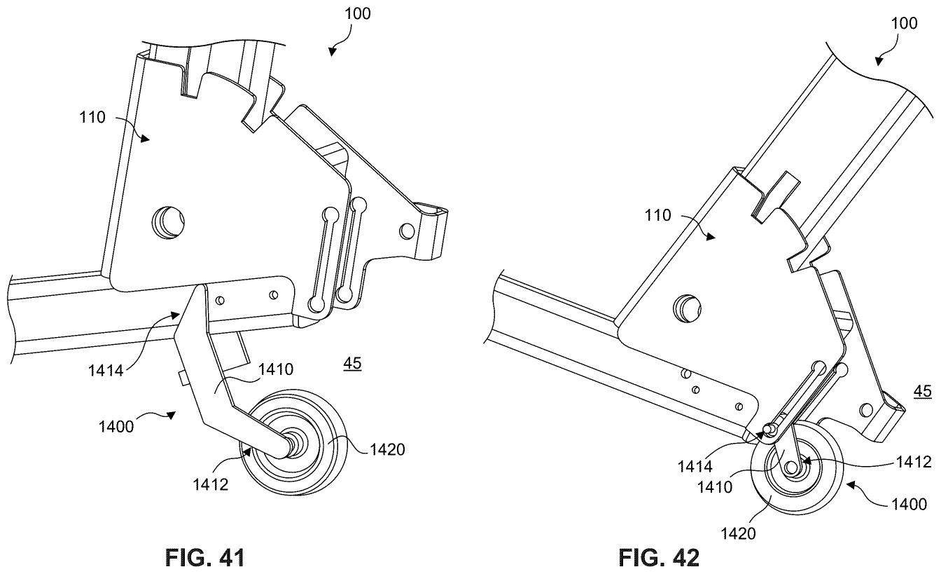

The wheel assembly 1400 shown in FIGS. 40-42 can include wheel arm 1410 and wheels 1420. Wheels 1420 can be rotatably coupled to a first end 1412 of wheel arm 1410. Wheels 1420 can support the load carrier system 100 to case transport of load carrier system 100, for example to and from a vehicle, or moving the load carrier system when not attached to a vehicle, etc. In some embodiments, wheel assembly 1400 includes one wheel 1420. In some embodiments, wheel assembly 1400 includes more than two wheels 1420. In the illustrative embodiment, shown in FIGS. 40-42, wheel assembly 1400 includes two wheels 1420. In some embodiments, wheel arm 1410 can couple to hub 110 at a second end 1414 of wheel arm 1410. In some embodiments, wheel arm 1410 can be fixed to hub 110 with fasteners. In some embodiments, second end 1414 is moveably coupled to hub 110 such that wheel assembly can be moved from a transport position 45 to a storage position or vice versa. In some embodiments, second end 1414 is slideably coupled to slots formed in hub 110 as shown, for example, in FIG. 41. In some embodiments, second end 1414 is rotatably coupled to hub 110 as shown, for example, in FIG. 42.

### Example License Plate Holder and Lighting Assembly

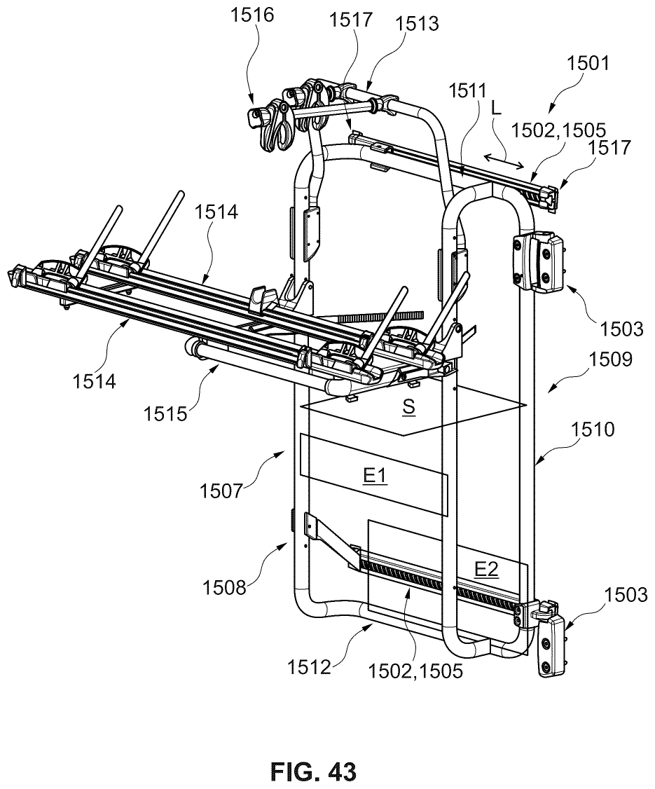

FIG. 43 shows a perspective view of a load carrier system 1501, which is configured as a bicycle carrier. The load carrier system 1501 has a carrying frame 1507. Carrying frame 1507 is configured for supporting a load supporting platform 1515 and a load attachment unit 1513. The load support platform 1515 is configured to support wheel trays 1514. Wheel trays 1514 can support a bicycle from below.

In some embodiments, load support platform 1515 can be pivotably fastened to the carrying frame 1507, for example, in such a way that it can be pivoted between a use position, as illustrated in FIG. 43. As shown in FIG. 43, the load support platform 1515 extends approximately perpendicularly to the support frame 1507, and a not shown stowage position in which the load support platform 1515 is folded onto the support frame 1507.

In some embodiments, load attachment unit 1513 is configured for attaching support arms 1516, which can also be referred to as spacers. Such support arms 1516 are configured to secure bicycles supported on the load support platform 1515 against tilting away laterally.

In some embodiments, the carrying frame 1507 can have a load supporting platform coupling section 1508, 1509 and a rear door coupling section 1511, 1512. Load supporting platform 1515 and load fastening unit 1513 can be fastened to the load supporting platform coupling section 1508, 1509. The rear door coupling section 1511, 1512 can serve to fasten the carrying frame 1507 to a rear door, for example by means of holders. The rear door coupling section 1511, 1512 can be formed by a transverse strut or by a section of a transverse strut of the carrying frame 1507. In the configuration shown in FIG. 43, an upper cross strut is used as the rear door coupling section 1511. In some embodiments, the rear door coupling section 1511 is coupled to an elongated support profile 1505, which serves as a fastening device 1502 and can be fastened to the rear door of a vehicle. Fastening clamps 1517 are provided at the ends of the elongated support profile 1505. The fastening clamps 1517 are designed for engagement with a door edge of the rear door. At least one fastening clamp 1517 can be coupled to the elongated support profile 1505 in such a way that it can be tensioned in the longitudinal direction L of the elongated support profile 1505. A door can be clamped between two fastening clamps 1517.

In some embodiments, the carrying frame 1507 can have a vehicle pillar coupling portion 1510. In some embodiments, the vehicle pillar coupling portion 1510 is to be understood as a portion which is coupled to the vehicle pillar or to a door hinge. In some embodiments, a fastening device 1503 can be used, as shown in FIG. 43. The vehicle pillar coupling portion 1510 can be formed by a longitudinal strut of the support frame 1507 or can be a part of a longitudinal strut of the support frame 1507. In the illustrative embodiment shown in FIG. 43, two fastening devices 1503 are provided on the vehicle pillar coupling portion 1510. The upper fastening device is provided in the region of an upper door hinge of a vehicle and the lower fastening device is provided in the region of a lower door hinge of a vehicle.

In some embodiments, the load supporting platform coupling sections 1508, 1509 may be arranged in a first plane E1. At least one rear door coupling section 1511 and the vehicle pillar coupling portion 1510 can be arranged in a second plane E2. In some embodiments, the first plane E1 and the second plane E2 are spaced apart from one another. In the illustrative embodiment shown in FIG. 43, the carrying frame 1507 is in a main extension direction formed symmetrically to an imaginary plane of symmetry S. The plane of symmetry S is perpendicular to the aforementioned planes E1 and E2 and divides the longitudinal struts into two parts of equal length.

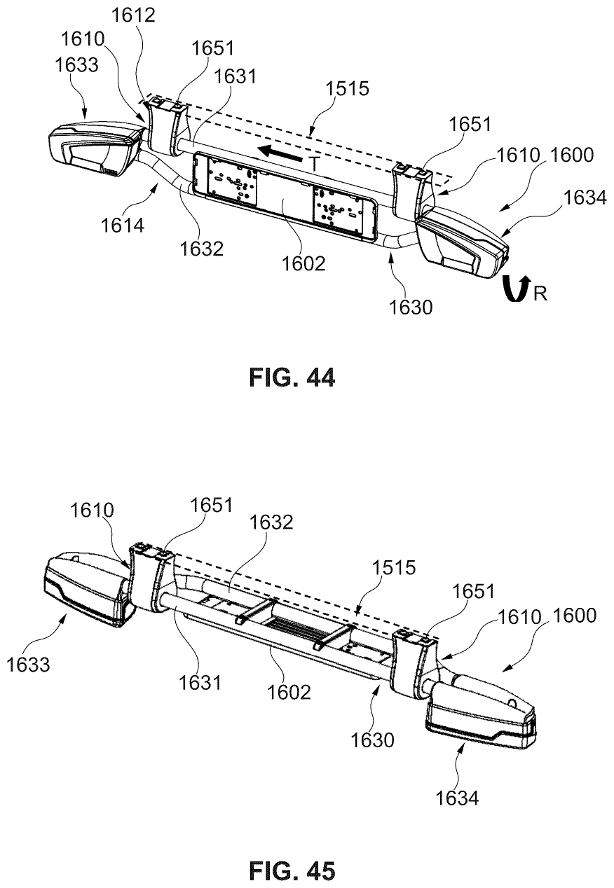

In the illustrative embodiment shown in FIG. 44, a carrying arrangement 1600 for a load carrier 1501 is shown. The carrying arrangement 1600 is configured for carrying an object. In the illustrative embodiment, a plurality of objects are carried by the carrying arrangement 1600, for example, a license plate holder 1602 for carrying a motor vehicle license plate, and lighting assemblies 1633, 1634, for example rear lights. The license plate holder 1602 and the lighting assemblies 1633, 1634 are held on the load carrier 1501 by means of the carrying arrangement 1600 such that the license plate holder 1602 and the lighting assemblies 1633, 1634 can be moved by a user from a use position into a stowage position. The use position is a position in which the object, for example, the license plate holder 1602 or a license plate fastened thereto or a lighting assembly 1633, 1634, is arranged vertically and thus visible for following vehicles. FIG. 44 illustrates, for example, a state in which the carrying arrangement 1600 is in a use configuration. FIG. 45 illustrates, for example, a state in which the carrying arrangement 1600 is in a stowage configuration. In the stowage configuration, the object can be folded onto the load carrier or a part of the load carrier, for example, onto the carrying frame 1507 or the load support platform 1515.

In some embodiments, the carrying arrangement 1600 includes a supporting portion 1612. The supporting portion 1612 can be fastened to the load carrier 1501 via suitable fastening devices 1651. In some embodiments, the fastening devices 1651 can be screws or bolts. In some embodiments, the supporting portion 1612 can be mounted on the load support platform 1515 of the load carrier 1501, as illustrated in FIGS. 44 and 45. The load support platform 1515 can be coupled to the carrying frame 1507 via a hinge arrangement. The load support platform 1515 can be pivotably fastened to the carrying frame 1507, for example, such that it can be pivoted between a use position, as illustrated in FIG. 43, in which the load support platform extends approximately perpendicularly to the carrying frame 1507, and a stowage position, not illustrated in more detail, in which the load support platform 1515 is folded onto the carrying frame 1507.

In some embodiments, the carrying arrangement 1600 includes a carrying portion 1614 for carrying the object. In some embodiments, the object can be a license plate holder 1602 or a lighting assembly 1633, 1634. In some embodiments, the carrying portion 1614 can be connected in an articulated manner to the supporting portion 1612. In some embodiments, the carrying portion 1614 and the supporting portion 1612 can form a joint 1610. In some embodiments, the carrying portion 1614 is arranged movable with respect to the supporting portion 1612. The carrying portion 1614 is held on the supporting portion 1612 such that it is arranged pivotable in a first direction R about an axis of rotation D between a use position and a stowage position. In some embodiments, the stowage position can be a position in which the carrying portion 1614 is folded onto the load support platform 1515, as illustrated in FIG. 45. In some embodiments, the use position can be a position in which the carrying portion 1614 is arranged perpendicularly to the load support platform 1515, as illustrated in FIG. 44.

In some embodiments, the carrying portion 1614 can include a frame arrangement 1630. In some embodiments, the frame arrangement 1630 can include a first frame portion 1631 and a second frame portion 1632. In some embodiments, the frame arrangement 1630 can be formed from one or more tube portions. The first frame portion 1631 can be mounted rotatable about an axis of rotation D on the supporting portion 1612. The second frame portion 1632 can be arranged spaced apart from the first frame portion 1631. A license plate holder 1602 can be fastened to the first frame portion 1631 and to the second frame portion 1632. The first frame portion 1631 and the second frame portion 1632 can be provided such that they extend in the transverse direction of the load carrier 1501. Lighting assemblies 1633, 1634 can be fastened to lateral end portions of the frame portions 1631 and 1632. For example, free end portions of the frame portions 1631 and 1632 can be received in corresponding recesses of the lighting assembly 1633, 1634, as can be seen, for example, in FIG. 45.

In some embodiments, the supporting portion 1612 can include a housing 1640. An opening 1641 can be provided in mutually opposite housing walls. In some embodiments, the first frame portion 1631 can be configured straight. The first frame portion 1631 can be inserted into the opening 1641. In some embodiments, the first frame portion 1631 and the opening 1641 are configured round, so that a first frame portion 1631 inserted in the opening 1641 is rotatably mounted in the opening 1641.

In some embodiments, a recess 1642 is formed in the housing 1640. Members of a locking arrangement are received in the recess 1642. In some embodiments, the locking arrangement is configured such that it locks the carrying portion 1614 in the use position and the stowage position with respect to the supporting portion 1612 such that the carrying portion 1614 remains or can be locked in the use position and in the stowage position. The use position is shown, for example, in FIG. 44. The stowage position is shown, for example, in FIG. 45. In some embodiments, the locking arrangement is configured to block a rotation of the carrying portion 1614 from the use position and the stowage position.

In some embodiments, the locking arrangement includes a first engaging portion 1650. The first engaging portion 1650 may associated with the carrying portion 1614. In some embodiments, the carrying portion 1614 is coupled to the engaging portion 1650. In some embodiments, the engaging portion 1650 is fastened to the frame portion 1631 such that the engaging portion 1650 and the frame portion 1631 move together. A rotation of the carrying portion 1614 or of the frame portion 1631 leads to a rotation of the engaging portion 1650. Due to this operative connection, a rotation of the carrying portion 1614 is blocked when a rotational movement of the engaging portion 1650 is blocked. The engaging portion 1650 can be configured as a portion, which extends in the radial direction away from the frame portion 1631. The engaging portion 1650 can be coupled directly to the frame portion 1631. In some embodiments, the engaging portion 1650 is configured as a part of a ring-like attachment 1647, through which the frame portion 1631 is passed. In some embodiments, the attachment is fastened to the frame portion 1631 with a suitable fastening device, for example, a screw 1648, by screwing the screw 1648 into a threaded opening 1633 on the frame portion 1631.

In some embodiments, the locking arrangement includes a second engaging portion 1643. In some embodiments, the second engaging portion 1643 is associated with the supporting portion 1612. In some embodiments, the second engaging portion 1643 is fastened to the supporting portion 1612. In some embodiments, the second engaging portion 1643 can be a plate-like member. The second engaging portion 1643 can be received in the recess 1642 such that it cannot be rotated with respect to the housing 1640 about the axis of rotation D. In some embodiments, the second engaging portion 1643 includes an opening 1646 which, when the engaging portion 1643 is received in the recess 1642, is aligned or brought into alignment with the opening 1641 in the housing. The frame portion 1631 can be passed through the opening 1641 and the opening 1646, through the housing 1640 and the second engaging portion 1643, and through an attachment 1647 provided therein. Although not shown, in some embodiments, the second engaging portion 1643 can also be formed integrally in the housing 1640 and does not have to be formed by a separate part which is inserted into the housing.

In some embodiments, the first engaging portion 1650 and the second engaging portion 1643 are configured such that they can form-fittingly engage when the carrying portion 1614 is in the use position. In some embodiments, the second engaging portion 1643 includes two recesses, a first recess 1644 and a second recess 1645. The first recess 1644 and the second recess 1645 are arranged at a predetermined angle to each other. In some embodiments, the angle can be 90 degrees. In some embodiments, the first recess 1644 and the second recess 1645 are configured as recesses in the axial direction of the axis of rotation. The first engaging portion 1650 is configured to be selectively engaged, when the first engaging portion 1650 is aligned with the first recess 1644 or the second recess 1645, by a movement along the axis of rotation D into the first recess 1644 or into the second recess 1645 in order to generate a positive engagement which blocks a rotation of the frame portion 1631 relative to the supporting portion 1612.

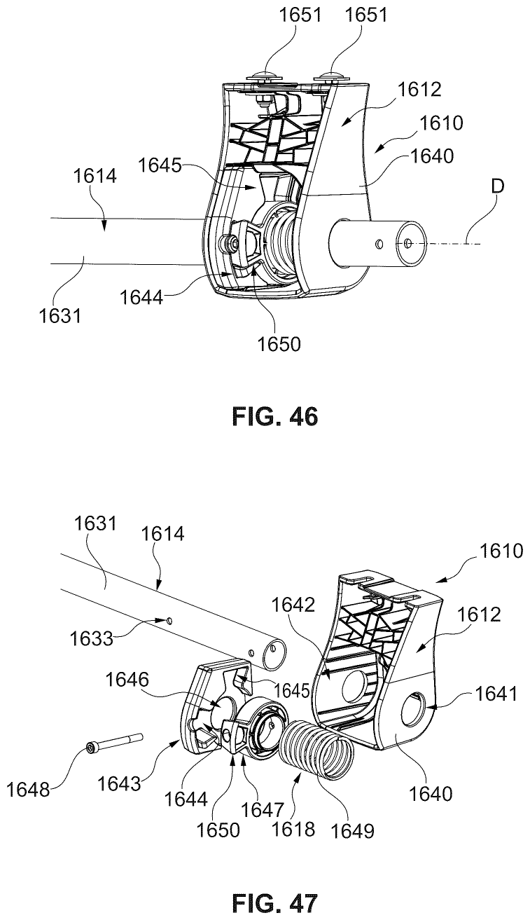

In the illustrative embodiment in FIG. 46, the first engaging portion 1650 is in positive mechanical engagement with the second engaging portion 1643. In some embodiments, the carrying portion 1614 is positioned in the use position, as illustrated in FIG. 44.

In some embodiments, the ring-like attachment 1647 also serves as a stop or supporting portion for an urging member 1618, which may be configured as a spring 1649. In some embodiments, between the ring-like attachment 1647 and a housing inner wall of the housing 1640 facing the ring-like attachment 1647, the spring 1649 is provided such that it applies a force on the ring-like attachment 1647 which urges or pretensions the ring-like attachment 1647 and the first engaging portion 1650 in the direction of the second engaging portion 1643. In some embodiments, an engagement between the first engaging portion 1650 and the second engaging portion 1643 can thus only be released by moving the first engaging portion 1650 away from the second engaging portion 1643 in the direction of the axis of rotation. In some embodiments, this can be done by a user displacing the carrying portion 1614, for example the frame arrangement 1630, in the direction T along the axis of rotation D and relative to the supporting portion 1612 against the urging force, as indicated in FIG. 44. In this way, the carrying portion 1614 can be moved into a release position in which the engagement between the first engaging portion 1650 and the second engaging portion 1643 is released and therefore a rotation of the carrying portion 1614 in the direction of rotation R relative to the supporting portion 1612 is possible. At the same time, the arrangement can be such that the engagement between the first engaging portion 1650 and the second engaging portion 1643 takes place automatically by the acting urging force as soon as the carrying portion 1614 reaches the use position or the stowage position. In some embodiments, the engaging portion 1650 is automatically engaged into the respective recess by the urging force of the urging member, so that a locking between the carrying portion 1614 and the supporting portion 1612 can take place automatically and without any action of the user.

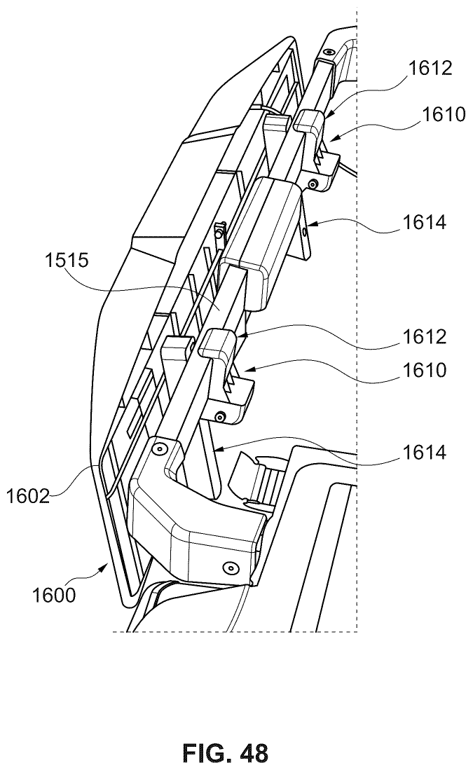

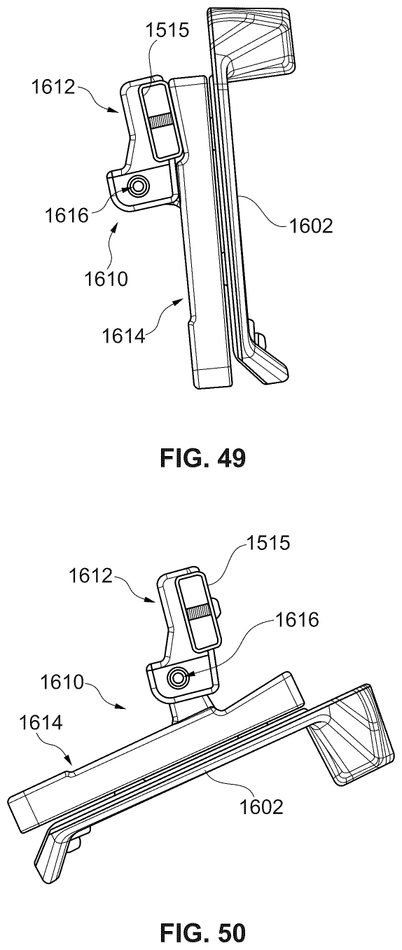

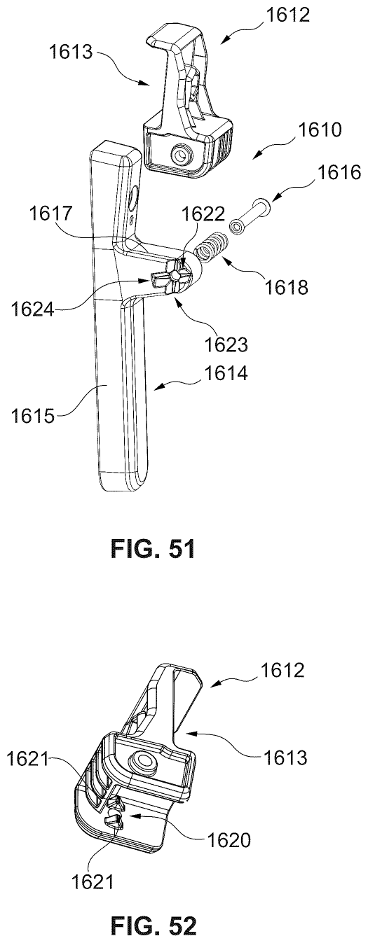

In some embodiments, carrying arrangement 1600 is shown, for example, in FIGS. 48 to 53. In some embodiments, the carrying arrangement 1600 is configured for carrying an object. In the illustrative embodiment shown in FIGS. 48 to 53, the object is a license plate holder 1602. The carrying arrangement 1600 includes a supporting portion 1612 and a carrying portion 1614. As shown, for example, in FIGS. 51 and 52, the supporting portion 1612 includes a recess 1613. In some embodiments, the recess 1613 serves for fastening to the load carrier 1501. In some embodiments, a part of the load support platform 1515 is received in the recess 1613, as shown, for example, in FIGS. 49 and 50. The supporting portion 1612 is fastened to the load support platform 1515 with a suitable fastening device, for example a screw.

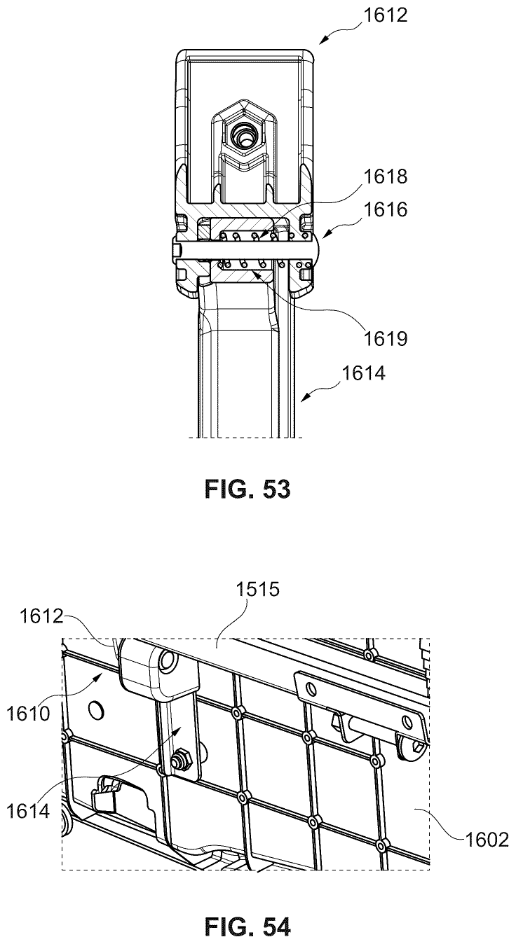

In some embodiments, the carrying portion 1614 is coupled in an articulated manner to the supporting portion 1612. In some embodiments, the carrying portion 1614 is rotatably coupled to the supporting portion 1612 via a pivot pin 1616 or bolt. Both portions form a joint 1610. In some embodiments, the carrying portion 1614 includes a coupling portion 1617 and an attachment portion 1615. In some embodiments, the fastening portion 1615 serves for carrying the license plate holder 1602. In some embodiments, the attachment portion 1615 can be configured oblong. The coupling portion 1617 is provided on the attachment portion 1615. In some embodiments, the coupling portion 1617 protrudes from the attachment portion 1615 in a direction which is transverse to the longitudinal direction of the attachment portion 1615 and faces away from the license plate holder 1602. In some embodiments, the coupling portion 1617 and the attachment portion 1615 can be formed integrally. An opening for receiving the pivot pin 1616 is provided in a free end portion of the coupling portion 1617. The free end portion of the coupling portion 1617 is received in a recess of the supporting portion 1612. FIG. 53 illustrates, for example, how the free end portion of the coupling portion 1617 is received in the recess of the supporting portion 1612 and the pivot pin 1616 is passed through the supporting portion 1612 and the coupling portion 1617.

In some embodiments, a first engaging portion 1622 is formed on a side of the free end portion of the coupling portion 1617. In some embodiments, the engaging portion 1622 includes two recesses 1623, 1624. A second engaging portion 1620 is formed on an inner wall delimiting the recess of the supporting portion 1612, which inner wall faces the engaging portion 1622 or the side of the coupling portion 1617. In some embodiments, the second engaging portion 1620 includes a protrusion 1621, which can engage in the recesses 1623, 1624 when the carrying portion 1614 is correspondingly positioned. The coupling portion 1617 is pretensioned via an urging member 1618, for example, a spring, such that the first engaging portion 1622 is urged in the direction of the second engaging portion 1620. The urging member 218 is received, as shown in FIG. 53, in a cup-shaped recess 1619 of the coupling portion 1617 and is supported on a base of the recess 1619 and on an inner wall of the supporting portion 1612. The coupling portion 1617 is displaceably held on the pivot pin 1616, so that an engagement between the first engaging portion 1622 and the second engaging portion 1620 can be established or released by a movement of the coupling portion 1617 along the pivot pin 1616. The urging member can be a spring, as illustrated, which is held on the pivot pin. In some embodiments, an engagement is automatically generated due to the action of the urging member 1618 when the engaging portions are positioned in alignment with each other. Such an engagement can then only be released by overcoming the urging force.

In some embodiments, a movement of the carrying portion 1614 along the axis of rotation releases the engagement. In some embodiments, the engaging portions can be configured such that a rotational movement of the carrying portion 1614 is at least partially translated into a movement along the axis of rotation. In some embodiments, the recesses and/or projections can be configured slanted in the direction of rotation, so that when a rotational force is applied on the carrying portion 1614, a force is generated in the direction of the axis of rotation on the coupling portion 1617, whereby the coupling portion is displaced in the lateral direction along the axis of rotation relative to the supporting portion 1612. In some embodiments, the recesses can be configured with slanted side surfaces on which the projections can slide. The side surfaces are configured such that a relative rotation between the projection and the side surface leads to a movement of the coupling portion 1617 in the direction of the axis of rotation. In some embodiments, the projections and recesses can get out of engagement or the engagement can be released by applying a sufficiently high rotational force on the carrying portion 1614. In some embodiments, the coupling portion 1617 includes recesses and the supporting portion 1612 includes protrusions, an inverse arrangement is also possible and provided according to an alternative embodiment.

In the illustrative embodiments shown in FIGS. 54 to 56, a carrying portion 1614 is rotatably coupled to a supporting portion 1612 by means of a pivot pin 1616. In some embodiments, the carrying portion 1614 is rotatably and displaceably received on the pivot pin 1616. In some embodiments, the pivot pin 1616 is coupled to the supporting portion 1612 on one side of the carrying portion 1614, for example, screwed into the supporting portion 1612. In some embodiments, the pivot pin 1616 and the supporting portion 1612 form an integral unit. The supporting portion 1612 is attached to a load support platform 1515. On the other side of the carrying portion 1614, an urging member 1618 is provided between an end portion of the pivot pin 1616 and the carrying portion 1614 and pushes the carrying portion 1614 onto the supporting portion 1612 or urges the carrying portion 1614 in the direction of the supporting portion 1612. In some embodiments, the carrying portion 1614 includes a first engaging portion with openings 1623, 1624. In some embodiments, the supporting portion 1612 includes a second engaging portion 1620 in the form of a protrusion, which can engage in one of the openings when the carrying portion 1614 is positioned in the use position or the stowage position.

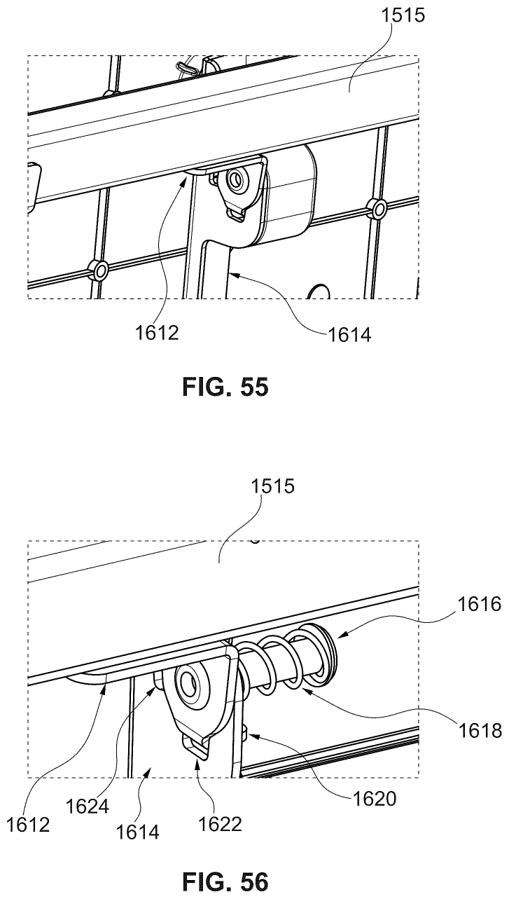

FIG. 56 shows a state in which the protrusion 1621 is engaged into the opening 1623 and a rotational movement of the carrying portion 1614 is blocked, according to an embodiment. In some embodiments, for releasing the locking, the carrying portion 1614 or a license plate holder 1602 mounted thereon can be displaced by a user along the axis of rotation defined by the pivot pin such that the protrusion is moved out of the opening 1623. The carrying portion 1614 and the license plate holder 1602 mounted thereon are moved into a release position in which a rotation of the carrying portion about the axis of rotation is possible. The carrying portion 1614 can then be rotated into the stowage position in which the second opening and the protrusion 1621 are aligned such that the protrusion 1621 can engage in the second opening. By the urging force acting on the carrying portion 1614, the protrusion is securely held in the respective opening and a rotation of the carrying portion 1614 is securely blocked. A housing can be provided over the urging member and the pivot pin, as shown, for example, in FIGS. 54 and 55.

It is to be appreciated that the Detailed Description section, and not the Brief Summary and Abstract sections, is intended to be used to interpret the claims. The Summary and Abstract sections may set forth one or more but not all embodiments of the load carrier system and apparatus, and thus, are not intended to limit the present embodiments and the appended claims.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A vehicle mounted load carrier, comprising:
a hub;
a support member rotatably coupled to the hub;
a tilt release mechanism coupled to the support member, the tilt release mechanism comprising a locking arm configured to move between a locked configuration and a released configuration such that in the locked configuration the support member is fixed relative to the hub and in the released configuration the support member can rotate between a first position and a second position; and
a tilt memory actuator moveably coupled to the hub or the support member and configured to maintain the locking arm in the released configuration when the locking arm is actuated from the locked configuration to the released configuration.

2. The load carrier of claim 1, wherein a plurality of recesses are formed in the hub or the support member, and wherein the tilt memory actuator moves between a closed configuration and an open configuration, wherein in the closed configuration the tilt memory actuator is disposed over at least a portion of a first recess of the plurality of recesses.

3. The load carrier of claim 2, wherein the tilt memory actuator linearly translates between the closed configuration and the open configuration.

4. The load carrier of claim 2, wherein in the closed configuration, the tilt memory actuator entirely covers the first recess.

5. The load carrier of claim 2, wherein the tilt memory actuator is biased into the closed configuration.

6. The load carrier of claim 2, wherein the locking arm is disposed in the first recess in the locked configuration.

7. The load carrier of claim 2, wherein the plurality of recesses are formed in the hub.

8. The load carrier of claim 2, wherein the tilt memory actuator comprises an actuating surface and a platform surface, and wherein the platform surface is configured to maintain the locking arm in the released configuration.

9. The load carrier of claim 8, wherein the locking arm is configured to contact the actuating surface of the tilt memory actuator when the support arm is rotated in a first direction to move the tilt memory actuator into the open configuration.

10. The load carrier of claim 9, wherein the platform surface is configured to maintain the locking arm in the released configuration when the support arm is rotated in a second direction opposite the first direction.

11. The load carrier of claim 8, wherein the platform surface is spaced apart from and disposed above a hub surface of the hub.

12. The load carrier of claim 1, wherein the tilt memory actuator is moveably coupled to the hub.

13. The load carrier of claim 1, wherein the support member is further configured to rotate to a third position different from the first position and the second position.

14. The load carrier of claim 1, wherein the tilt memory actuator comprises a plate and a protrusion, and wherein the protrusion is configured to maintain the locking arm in the released configuration.

15. The load carrier of claim 14, wherein a plurality of recesses are formed in the hub, and wherein the tilt memory actuator moves between a closed configuration and an open configuration, wherein in the closed configuration the protrusion is disposed above at least one recess of the plurality of recesses.

16.-106. (canceled)
